(19) United States
(12) Patent Application Publication
(10) Pub. No.: US 2026/0181113 A1
(43) Pub. Date: Jun. 25, 2026

(54) CONTROL DEVICE, CONTROL METHOD, AND CONTROL PROGRAM

(71) Applicant: FUJIFILM Corporation, Tokyo (JP)

(72) Inventor: Kazuyuki ITAGAKI, Saitama (JP)

(73) Assignee: FUJIFILM Corporation, Tokyo (JP)

(21) Appl. No.: 19/543,969

(22) Filed: Feb. 19, 2026

Related U.S. Application Data
(63) Continuation of application No. PCT/JP2024/029244, filed on Aug. 19, 2024.

(30) Foreign Application Priority Data
Aug. 28, 2023 (JP) 2023-138035

(51) Int. Cl. H04N 9/31; G01J 3/50

(52) U.S. Cl. CPC H04N 9/3182; G01J 3/50; H04N 9/3147

(57) ABSTRACT

A control device includes a processor. The processor is configured to: acquire a first colorimetric value of light of a first color that is an adjustment color and is projected from a first projection device; acquire a second colorimetric value of light of the first color that is projected from a second projection device; and determine a first color adjustment parameter for bringing a position of the first colorimetric value in a specific color space closer to a position of the second colorimetric value in the specific color space based on adjustment data for the first color, the first colorimetric value, and the second colorimetric value, the adjustment data indicating a relationship between a color adjustment parameter and the position in the specific color space.

### CROSS-REFERENCE TO RELATED APPLICATIONS

This is a continuation of International Application No. PCT/JP2024/029244 filed on Aug. 19, 2024, and claims priority from Japanese Patent Application No. 2023-138035 filed on Aug. 28, 2023, the entire content of which is incorporated herein by reference.

### BACKGROUND OF THE INVENTION

### 1. Field of the Invention

The present invention relates to a control device, a control method, and a storage medium.

### 2. Description of the Related Art

JP2022-077773A discloses an image projection system comprising: a specifying unit that specifies a video region in which projected image information is displayed on a screen; a projection control unit that causes a projection unit to project an adjustment pattern that is generated to be projected to the specified video region, the adjustment pattern being used to obtain an adjustment value used in adjusting a display aspect of the image information; an image generation device that generates image information based on input information; and a projection unit that projects the generated image information onto the screen.

JP2017-083672A discloses an image projection system comprising: a first projector; and a second projector, in which the first projector includes a first projection unit that projects a first image and a first imaging unit that images a range including at least a part of the first image projected by the first projection unit and at least a part of a second image projected by the second projector, the second projector includes a second projection unit that projects the second image, and the first projector determines a target color based on a first captured image obtained by imaging at least a part of the first image projected by the first projection unit with the first imaging unit and obtains first correction data for correcting a color of a projection image of the second projector to the target color based on a second captured image obtained by imaging at least a part of the second image projected by the second projection unit with the first imaging unit.

### SUMMARY OF THE INVENTION

One embodiment according to the technology of the present disclosure provides a control device, a control method, and a storage medium capable of performing color adjustment between a plurality of projectors in a short time.

A control device according to the present invention includes a processor, in which the processor is configured to: acquire a first colorimetric value of light of a first color that is an adjustment color and is projected from a first projection device; acquire a second colorimetric value of light of the first color that is projected from a second projection device; and determine a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.

In addition, a control method according to the present invention is a control method of a control device including a processor, the processor being configured to: acquire a first colorimetric value of light of a first color that is an adjustment color and is projected from a first projection device; acquire a second colorimetric value of light of the first color that is projected from a second projection device; and determine a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.

In addition, a storage medium according to the present invention is a storage medium storing a control program for causing a processor included in a control device to execute a process of: acquiring a first colorimetric value of light of a first color that is an adjustment color and is projected from a first projection device; acquiring a second colorimetric value of light of the first color that is projected from a second projection device; and determining a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.

According to the present invention, it is possible to provide a control device, a control method, and a storage medium capable of performing color adjustment between a plurality of projectors in a short time.

### BRIEF DESCRIPTION OF THE DRAWINGS

FIG. 1 is a diagram showing an example of a projection system 100 of an embodiment.

FIG. 2 is a diagram showing an example of a first projection device 10a and a second projection device 10b.

FIG. 3 is a schematic diagram showing an example of an internal configuration of a projection section 1.

FIG. 4 is a schematic diagram showing an exterior configuration of a projection device 10.

FIG. 5 is a schematic cross-sectional view of an optical unit 106 of the projection device 10 shown in FIG. 4.

FIG. 6 is a diagram showing an example of a hardware configuration of a computer 50.

FIG. 7 is a diagram showing a state in which a look-up table for color adjustment is generated.

FIG. 8 is a diagram showing an example of a step of generating the look-up table.

FIG. 9 is a flowchart showing a generation process of the look-up table by a processor 51 of the computer 50.

FIG. 10 is a diagram showing an example of a color adjustment parameter P (p1, p2, p3).

FIG. 11 is a diagram showing an example of the look-up table in a case where the adjustment color is white.

FIG. 12 is a flowchart showing a color adjustment process using the look-up table by the processor 51 of the computer 50.

FIG. 13 is a flowchart showing a determination process of the color adjustment parameter by the processor 51.

FIG. 14 is a diagram showing setting of a position in a Lab color space in the determination process of the color adjustment parameter.

FIG. 15 is a diagram showing determination of the color adjustment parameter in the determination process of the color adjustment parameter.

FIG. 16 is a flowchart showing a modification example of the color adjustment process using the look-up table by the processor 51.

FIG. 17 is a flowchart showing a modification example of the determination process of the color adjustment parameter by the processor 51.

FIG. 18 is a diagram showing an example of setting a projection device having a large Y (luminance) as an adjustment projection device (Adj).

FIG. 19 is a diagram showing an example of setting a projection device having a small Y (luminance) as an adjustment projection device (Adj).

FIG. 20 is a diagram showing an example of determining the color adjustment parameter based on a chromaticity difference.

FIG. 21 is a diagram showing an example of color adjustment in an environment in which disturbance light is present.

FIG. 22 is a diagram showing an example of colorimetry of the disturbance light in an environment in which only the disturbance light is present.

FIG. 23 is a diagram showing an example of a state in which a colorimetry position is not stable during colorimetry.

FIG. 24 is a diagram showing an example of a guide line 92 that guides the colorimetry position.

FIG. 25 is a diagram showing a state in which the guide line 92 shown in FIG. 24 disappears.

FIG. 26 is a diagram showing a modification example of the guide line that guides the colorimetry position.

FIG. 27 is a diagram showing an example of a projection range of an image during colorimetry.

FIG. 28 is a schematic diagram showing another exterior configuration of the projection device 10.

FIG. 29 is a schematic cross-sectional view of the optical unit 106 of the projection device 10 shown in FIG. 21.

### DESCRIPTION OF THE PREFERRED EMBODIMENTS

Hereinafter, an example of an embodiment of the present invention will be described with reference to the drawings.

### Embodiment

### <Projection System 100 of Embodiment>

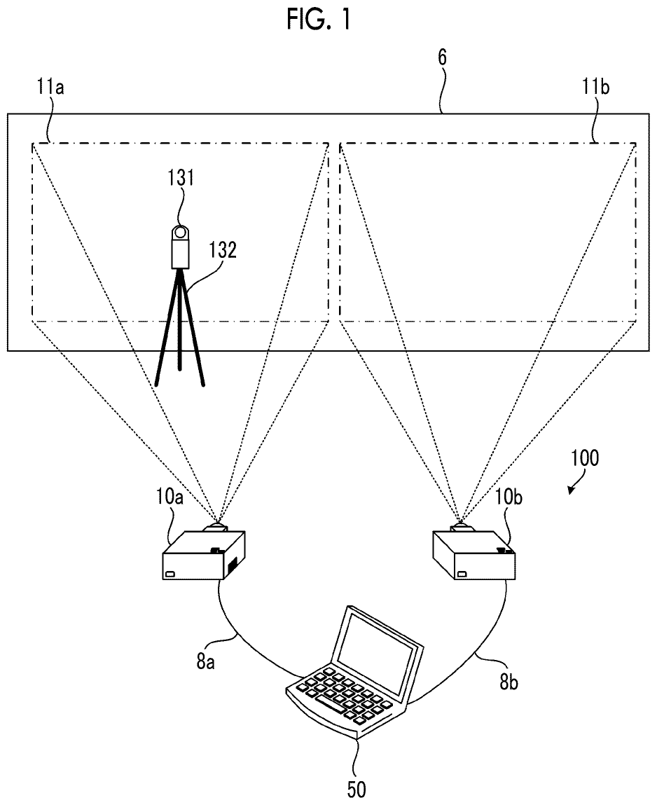

FIG. 1 is a diagram showing an example of a projection system 100 of the embodiment. As shown in FIG. 1, the projection system 100 includes a first projection device 10a, a second projection device 10b, a computer 50, and a colorimeter 131. The computer 50 is an example of a “control device” in the present invention.

The computer 50 is communicable with the first projection device 10a and the second projection device 10b. In the example shown in FIG. 1, the computer 50 is connected to the first projection device 10a via a communication cable 8a to be capable of communicating with the first projection device 10a. In addition, the computer 50 is connected to the second projection device 10b via a communication cable 8b to be capable of communicating with the second projection device 10b. The computer 50 may be directly or indirectly connected to the first projection device 10a and the second projection device 10b. In addition, the first projection device 10a and the second projection device 10b may be configured to be integrated with the computer 50.

The first projection device 10a and the second projection device 10b are projection devices that can perform projection onto a projection object 6. The colorimeter 131 is a device that can measure a colorimetric value of light projected from the first projection device 10a and the second projection device 10b onto the projection object 6.

The colorimeter 131 measures, for example, tristimulus values XYZ of an XYZ color system. The colorimeter 131 measures the colorimetric value, for example, in a state of being attached to a tripod 132. FIG. 1 shows a state in which the colorimeter 131 measures the colorimetric value of the light projected from the first projection device 10a. The computer 50 acquires the colorimetric value measured by the colorimeter 131. The colorimetric value may be acquired by imaging with a camera (an internal camera of the first projection device 10a or the second projection device 10b or the computer 50, or an external camera). In addition, in the present embodiment, the computer 50 is an example of the control device, but the first projection device 10a or the second projection device 10b may be an example of the control device.

The projection object 6 is an object such as a wall having a projection surface on which a projection image is displayed by the first projection device 10a and the second projection device 10b. In the example shown in FIG. 1, the projection surface of the projection object 6 is a rectangular flat wall. The wall is, for example, a projection surface on which unevenness of a joint of a wall surface, an obstacle such as an embedded socket on the wall surface, an appearance of the wall surface, or the like may be provided, or a shadow of another object may occur. It is assumed that upper, lower, left, and right sides of the projection object 6 in FIG. 1 are upper, lower, left, and right sides of the actual projection object 6.

A projection range 11a shown by a one-dot dashed line on the left side is a region in the projection object 6 that is irradiated with projection light by the first projection device 10a. The projection range 11a is a part or an entirety of a projectable range within which the projection can be performed by the first projection device 10a. A projection range 11b shown by a one-dot dashed line on the right side is a region in the projection object 6 that is irradiated with projection light by the second projection device 10b. The projection range 11b is a part or an entirety of a projectable range within which the projection can be performed by the second projection device 10b. In the example shown in FIG. 1, the projection ranges 11a and 11b are rectangular.

<First Projection Device 10a and Second Projection Device 10b>

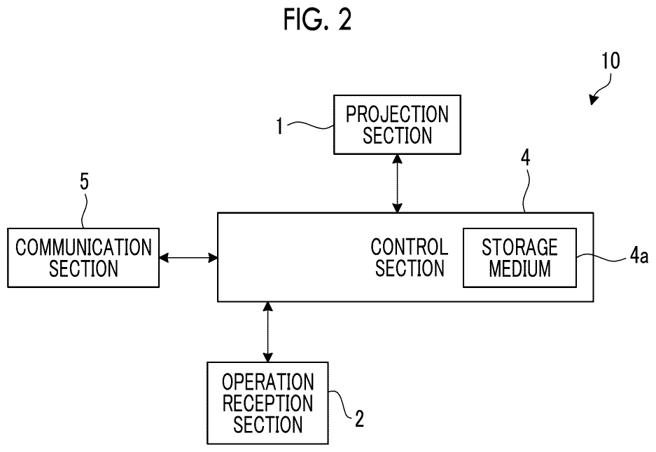

FIG. 2 is a diagram showing an example of the first projection device 10a and the second projection device 10b. Each of the first projection device 10a and the second projection device 10b is composed of, for example, a projection device 10 shown in FIG. 2. The projection device 10 comprises a projection section 1, a control section 4, an operation reception section 2, and a communication section 5. The projection section 1 is composed of, for example, a liquid crystal projector or a projector using liquid crystal on silicon (LCOS). Hereinafter, the projection section 1 will be described as a liquid crystal projector.

The control section 4 controls projection performed by the projection device 10. The control section 4 is a device including a control section composed of various processors, a communication interface (not shown) for communicating with each section, and a storage medium 4a such as a hard disk, a solid state drive (SSD), or a read-only memory (ROM) and integrally controls the projection section 1. Examples of the various processors of the control section of the control section 4 include a central processing unit (CPU) that is a general-purpose processor performing various processes by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute a specific process.

More specifically, a structure of these various processors is an electric circuit in which circuit elements such as semiconductor devices are combined. The control section of the control section 4 may be composed of one of the various processors or may be composed of a combination of two or more processors of the same type or different types (for example, a combination of a plurality of FPGAs or a combination of a CPU and an FPGA).

The operation reception section 2 detects an instruction from a user (user instruction) by receiving various operations from the user. The operation reception section 2 may be a button, a key, a joystick, or the like provided in the control section 4 or may be a reception unit or the like that receives a signal from a remote controller that performs a remote operation of the control section 4.

The communication section 5 is a communication interface capable of communicating with the computer 50. The communication section 5 may be a wired communication interface that performs wired communication as shown in FIG. 1, or may be a wireless communication interface that performs wireless communication.

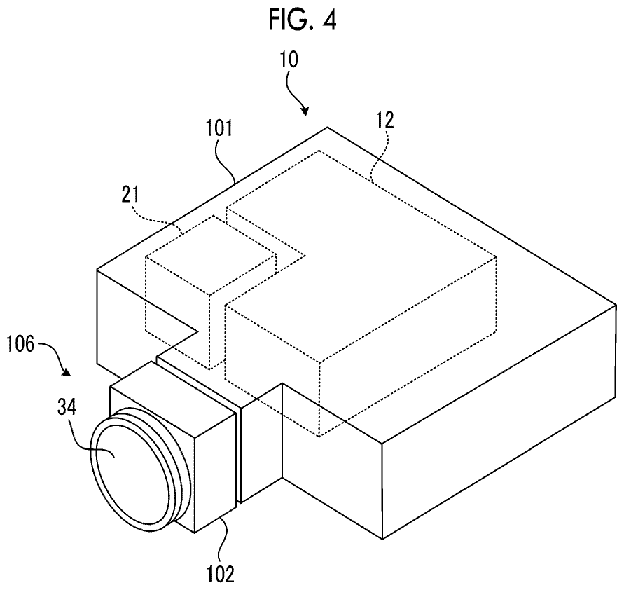

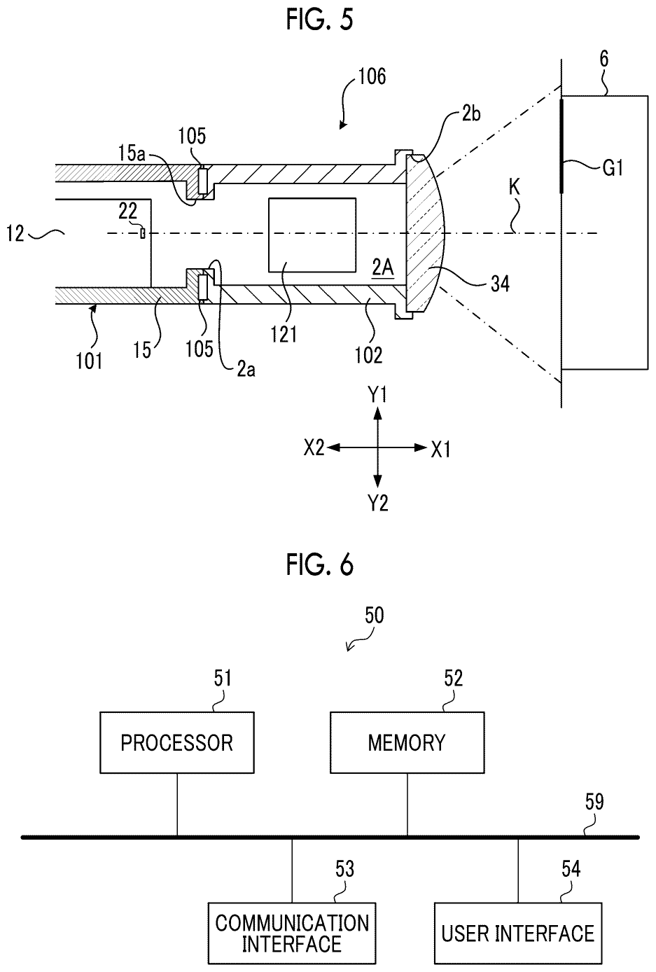

It should be noted that the projection section 1, the control section 4, and the operation reception section 2 are implemented by, for example, one device (for example, refer to FIGS. 4 and 5). Alternatively, the projection section 1, the control section 4, and the operation reception section 2 may be separate devices that cooperate by performing communication with each other.

### <Internal Configuration of Projection Section 1>

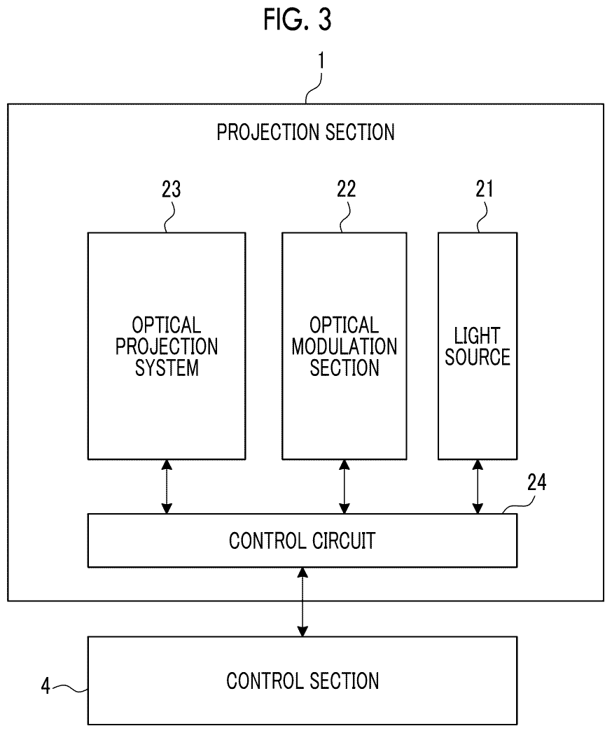

FIG. 3 is a schematic diagram showing an example of an internal configuration of the projection section 1. As shown in FIG. 3, the projection section 1 of the projection device 10 shown in FIG. 2 comprises a light source 21, an optical modulation section 22, an optical projection system 23, and a control circuit 24. The light source 21 includes a light emitting element such as a laser or a light emitting diode (LED) and emits, for example, white light.

The optical modulation section 22 is composed of three liquid crystal panels (optical modulation elements) that emit respective color images by modulating, based on image information, light of respective colors which is emitted from the light source 21 and separated into three colors, that is, red, blue, and green, by a color separation mechanism (not shown), and a dichroic prism that mixes color images emitted from the three liquid crystal panels and that emits the mixed color image in the same direction. The color images may be emitted by respectively mounting filters of red, blue, and green in the three liquid crystal panels and modulating the white light emitted from the light source 21 via respective liquid crystal panels.

The light from the light source 21 and the optical modulation section 22 is incident on the optical projection system 23. The optical projection system 23 includes at least one lens and is composed of, for example, a relay optical system. The light that has passed through the optical projection system 23 is projected to the projection object 6.

In the projection object 6, a region irradiated with the light transmitted through an entire range of the optical modulation section 22 is a projectable range within which the projection can be performed by the projection section 1. In the projectable range, a region that is irradiated with the light actually transmitted through the optical modulation section 22 is a projection range of the projection section 1 (the projection range 11a or the projection range 11b). For example, in the projectable range, a size, a position, and a shape of the projection range of the projection section 1 are changed by controlling a size, a position, and a shape of a region through which the light is transmitted in the optical modulation section 22.

By controlling the light source 21, the optical modulation section 22, and the optical projection system 23 based on display data input from the control section 4, the control circuit 24 projects an image based on the display data onto the projection object 6. The display data input into the control circuit 24 is composed of three pieces of data including red display data, blue display data, and green display data.

In addition, the control circuit 24 enlarges or reduces the projection range of the projection section 1 by changing the optical projection system 23 based on a command input from the control section 4. In addition, the control section 4 may move the projection range of the projection section 1 by changing the optical projection system 23 based on an operation received from the user by the operation reception section 2.

In addition, the projection device 10 comprises a shift mechanism that mechanically or optically moves the projection range of the projection section 1 while maintaining an image circle of the optical projection system 23. The image circle of the optical projection system 23 is a region in which the projection light incident on the optical projection system 23 appropriately passes through the optical projection system 23 in terms of light fall-off, color separation, edge part curvature, and the like.

The shift mechanism is implemented by at least any of an optical system shift mechanism that performs optical system shifting or an electronic shift mechanism that performs electronic shifting.

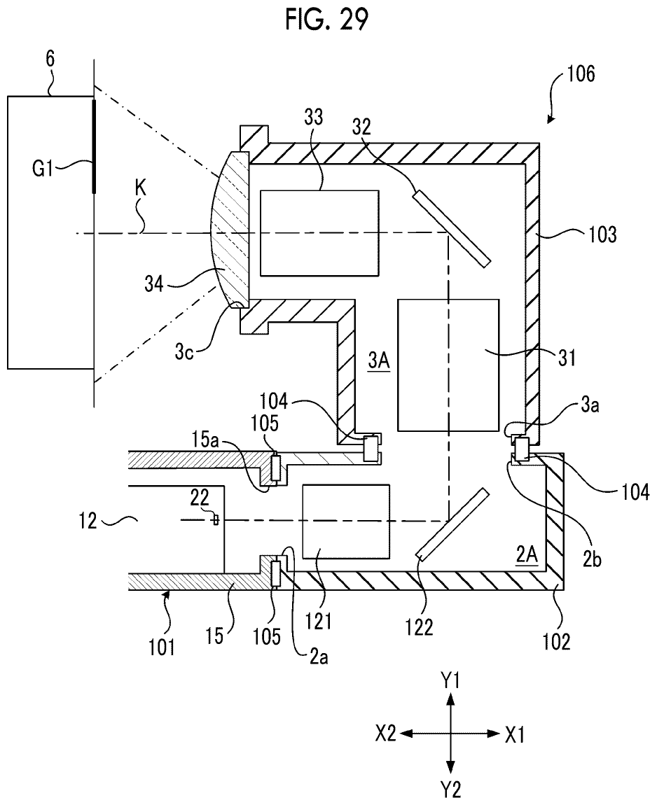

The optical system shift mechanism is, for example, a mechanism that moves the optical projection system 23 in a direction perpendicular to an optical axis (for example, refer to FIGS. 5 and 29), or a mechanism that moves the optical modulation section 22 in the direction perpendicular to the optical axis instead of moving the optical projection system 23. In addition, the optical system shift mechanism may perform the movement of the optical projection system 23 and the movement of the optical modulation section 22 in combination with each other.

The electronic shift mechanism is a mechanism that performs pseudo shifting of the projection range by changing a range through which the light is transmitted in the optical modulation section 22.

In addition, the projection device 10 may comprise a projection direction changing mechanism that moves the image circle of the optical projection system 23 and the projection range. The projection direction changing mechanism is a mechanism that changes a projection direction of the projection section 1 by changing an orientation of the projection section 1 via mechanical rotation (for example, refer to FIG. 29).

### <Mechanical Configuration of Projection Device 10>

FIG. 4 is a schematic diagram showing an exterior configuration of the projection device 10. FIG. 5 is a schematic cross-sectional view of an optical unit 106 of the projection device 10 shown in FIG. 4. FIG. 5 shows a cross section in a plane along an optical path of light emitted from a body part 101 shown in FIG. 4.

As shown in FIG. 4, the projection device 10 comprises the body part 101 and the optical unit 106 that is provided to protrude from the body part 101. In the configuration shown in FIG. 4, the operation reception section 2; the control section 4; the light source 21, the optical modulation section 22, and the control circuit 24 in the projection section 1; and the communication section 5 are provided in the body part 101. The optical projection system 23 in the projection section 1 is provided in the optical unit 106.

The optical unit 106 comprises a first member 102 supported by the body part 101. The optical unit 106 may be configured to be attachable to and detachable from the body part 101 (in other words, configured to be interchangeable).

As shown in FIG. 5, the body part 101 includes a housing 15 in which an opening 15a for passing light is formed in a part connected to the optical unit 106.

As shown in FIG. 4, the light source 21 and an optical modulation unit 12 including the optical modulation section 22 (refer to FIG. 3) that generates an image by spatially modulating the light emitted from the light source 21 based on input image data are provided inside the housing 15 of the body part 101. The light emitted from the light source 21 is incident on the optical modulation section 22 of the optical modulation unit 12 and is spatially modulated and emitted by the optical modulation section 22.

As shown in FIG. 5, the image formed by the light spatially modulated by the optical modulation unit 12 is incident on the optical unit 106 by passing through the opening 15a of the housing 15 and is projected onto the projection object 6. Accordingly, an image G1 is visible to an observer.

The optical unit 106 includes the first member 102 having a hollow portion 2A connected to the inside of the body part 101, a first optical system 121 disposed in the hollow portion 2A, a lens 34, and a first shift mechanism 105.

The first member 102 is a member having, for example, a rectangular cross-sectional exterior, in which an opening 2a and an opening 2b are formed on surfaces parallel to each other. The first member 102 is supported by the body part 101 in a state where the opening 2a is disposed at a position facing the opening 15a of the body part 101. The light emitted from the optical modulation section 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 5 and its opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 5 will be referred to as a direction Y1, and a downward direction in FIG. 5 will be referred to as a direction Y2. In the example in FIG. 5, the projection device 10 is disposed such that the direction Y2 is a vertical direction.

The optical projection system 23 shown in FIG. 3 is composed of the first optical system 121 and the lens 34 in the example in FIG. 5. An optical axis K of this optical projection system 23 is shown in FIG. 5. The first optical system 121 and the lens 34 are disposed in this order from an optical modulation section 22 side along the optical axis K.

The first optical system 121 includes at least one lens and guides, to the lens 34, the light that is incident on the first member 102 from the body part 101 and that travels in the direction X1.

The lens 34 closes the opening 2b formed in an end part of the first member 102 on a direction X1 side and is disposed in the end part. The lens 34 projects the light incident from the first optical system 121 onto the projection object 6.

The first shift mechanism 105 is a mechanism for moving the optical axis K of the optical projection system (in other words, the optical unit 106) in a direction perpendicular to the optical axis K (the direction Y in FIG. 5). Specifically, the first shift mechanism 105 is configured to change a position of the first member 102 in the direction Y with respect to the body part 101. The first shift mechanism 105 may manually move the first member 102 or electrically move the first member 102.

FIG. 5 shows a state where the first member 102 is moved as far as possible to a direction Y1 side by the first shift mechanism 105. By moving the first member 102 in the direction Y2 by means of the first shift mechanism 105 from the state shown in FIG. 5, a relative position between a center of the image (in other words, a center of a display surface) formed by the optical modulation section 22 and the optical axis K changes, and the image G1 projected onto the projection object 6 can be shifted (translated) in the direction Y2.

The first shift mechanism 105 may be a mechanism that moves the optical modulation section 22 in the direction Y instead of moving the optical unit 106 in the direction Y. Even in this case, the image G1 projected onto the projection object 6 can be moved in the direction Y.

### <Hardware Configuration of Computer 50>

FIG. 6 is a diagram showing an example of a hardware configuration of the computer 50. As shown in FIG. 6, the computer 50 shown in FIG. 1 comprises a processor 51, a memory 52, a communication interface 53, and a user interface 54. The processor 51, the memory 52, the communication interface 53, and the user interface 54 are connected by, for example, a bus 59.

The processor 51 is a circuit that processes signals, and is, for example, a CPU that controls the entire computer 50. The processor 51 may be implemented by other digital circuits such as an FPGA and a digital signal processor (DSP). In addition, the processor 51 may be implemented by combining a plurality of digital circuits.

The memory 52 includes, for example, a main memory and an auxiliary memory. The main memory is, for example, a random-access memory (RAM). The main memory is used as a work area of the processor 51.

The auxiliary memory is, for example, a non-volatile memory such as a magnetic disk, an optical disc, or a flash memory. Various programs for operating the computer 50 are stored in the auxiliary memory. The programs stored in the auxiliary memory are loaded into the main memory and executed by the processor 51.

In addition, the auxiliary memory may include a portable memory that can be attached to and detached from the computer 50. Examples of the portable memory include a universal serial bus (USB) flash drive, a memory card such as a secure digital (SD) memory card, and an external hard disk drive.

The communication interface 53 is a communication interface that performs communication with the outside of the computer 50 (for example, the first projection device 10a and the second projection device 10b). The communication interface 53 is controlled by the processor 51. The communication interface 53 may be a wired communication interface that performs wired communication or a wireless communication interface that performs wireless communication, or may include both of the wired communication interface and the wireless communication interface.

The user interface 54 includes, for example, an input device that receives operation input from a user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 54 is controlled by the processor 51.

### <Generation of Look-Up Table (LUT) for Color Adjustment>

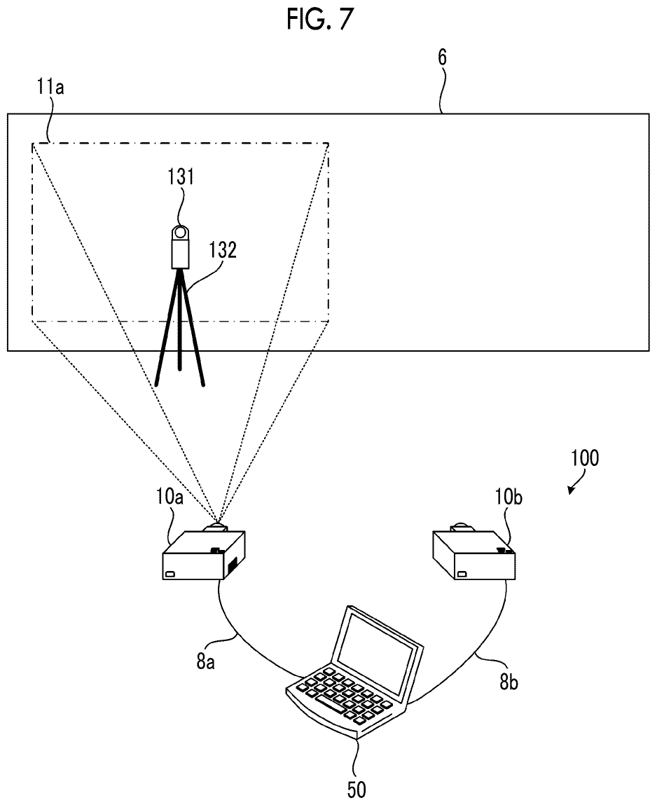

The generation of the look-up table for color adjustment will be described with reference to FIGS. 7 to 11.

FIG. 7 is a diagram showing a state in which the look-up table for color adjustment is generated. The computer 50 generates the look-up table for color adjustment in advance in order to perform color adjustment between the projection of the first projection device 10a and the projection of the second projection device 10b. The look-up table is generated by using one projection device selected at random.

The selected projection device may be, for example, one of the first projection device 10a or the second projection device 10b described in FIG. 1, or may be a projection device different from these. However, the first projection device 10a, the second projection device 10b, and the other projection device are projection devices having the same or similar projection characteristics. The same or similar projection characteristics mean, for example, that the projection device has the same optical design (for example, the same model).

In the present example, as shown in FIG. 7, the look-up table is generated by using the first projection device 10a. The location at which the look-up table is generated may be a site where the projection system 100 is installed or may be a location (for example, a manufacturing factory) different from the site. The look-up table (LUT) is an example of “adjustment data” in the present invention.

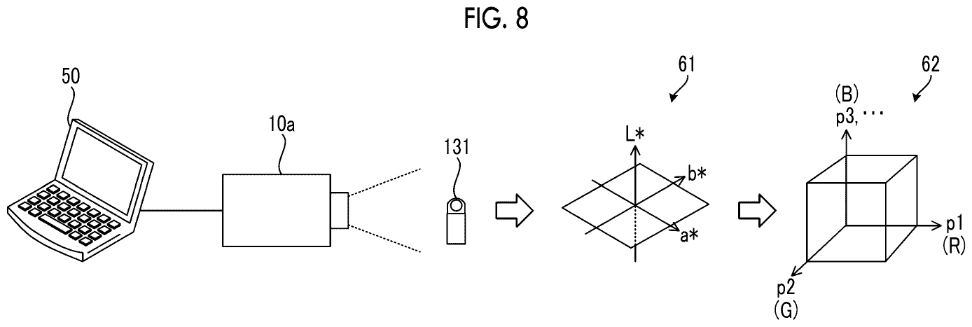

FIG. 8 is a diagram showing an example of a step of generating the look-up table. First, in order to generate the look-up table for color adjustment of a predetermined color, the computer 50 creates an image of a test pattern I (r, g, b) of the predetermined color and transmits the created test pattern I (r, g, b) to the first projection device 10a.

A configuration in which color adjustment is performed for a plurality of colors (for example, white, cyan, magenta, and the like) may be adopted as described below, but a case where the adjustment color is white will be described here. In a case where the adjustment color is white, the test pattern is a test pattern I (r, g, b=255). White (r, g, b=255) is an example of a “first color” in the present invention. In a case where the adjustment color is cyan, the test pattern is a test pattern I (r, g, b=0, 255, 255), and in a case where the adjustment color is magenta, the test pattern is a test pattern I (r, g, b=255, 0, 255).

In addition, in this case, the computer 50 changes the color adjustment parameter P (p1, p2, . . . , pn) as the parameter and sequentially transmits the test pattern I having different color adjustment parameters P to the first projection device 10a. In the present example, the color adjustment parameter P (p1, p2, . . . , pn) is a parameter for gain adjustment for each of R, G, and B, which are color components of the image. Therefore, the gain of R is p1, the gain of G is p2, the gain of B is p3, and the color adjustment parameter P=(p1, p2, p3).

The color adjustment parameter P is a parameter for performing color adjustment (change) of the projection. The color adjustment parameter is not limited to the gain value for each of R, G, and B, and may be, for example, an offset value for each of R, G, and B or a combination of the gain value and the offset value. In addition, the color adjustment parameter may include other parameters such as a hue.

The first projection device 10a sequentially projects the test pattern I (r, g, b) in which the color adjustment parameter P received from the computer 50 is changed toward the projection object 6.

The colorimeter 131 measures the XYZ values (XYZ^{(r, g, b=255)} (p1, p2, p3)) corresponding to the white test pattern I in which the color adjustment parameter P projected from the first projection device 10a is changed.

The computer 50 sets the XYZ value of the color adjustment parameter P having the maximum luminance (maximum brightness) in white among the XYZ values for the white test pattern measured by the colorimeter 131 as a reference white. The computer 50 converts the XYZ value of the reference white into, for example, a value in a Lab color space 61. L indicates brightness, and a and b indicate chromaticity. This color space is a space in which a relative color value based on the reference white is represented. The computer 50 converts each XYZ value in which the color adjustment parameter P is changed into a value in the Lab color space 61. The Lab color space 61 is an example of a “specific color space” in the present invention. As the specific color space, for example, a “Luv color space” may be used.

The computer 50 creates a look-up table 62 indicating a relationship between the color adjustment parameter P and the position in the Lab color space 61. The look-up table 62 is a multi-dimensional look-up table in which the input is p1, p2, . . . , pn and the output is L*a*b*. In the present example, since the color adjustment parameter P (p1, p2, p3) is the gain values of R, G, and B, the look-up table is three-dimensional.

The absolute colors of the adjustment color (for example, white) are different between the projection devices (for example, the first projection device 10a and the second projection device 10b). In the present invention, the projection devices having the same or similar projection characteristics are projected with the same tendency of relative color movement based on the color adjustment parameter of the projection device for a certain color (adjustment color), and the color adjustment of the projection device is performed by using the look-up table in which the relative color movement is recorded. The projection device having the same or similar projection characteristics described above is a projection device having projection characteristics that can be regarded as having the same tendency of relative color movement based on the color adjustment parameter.

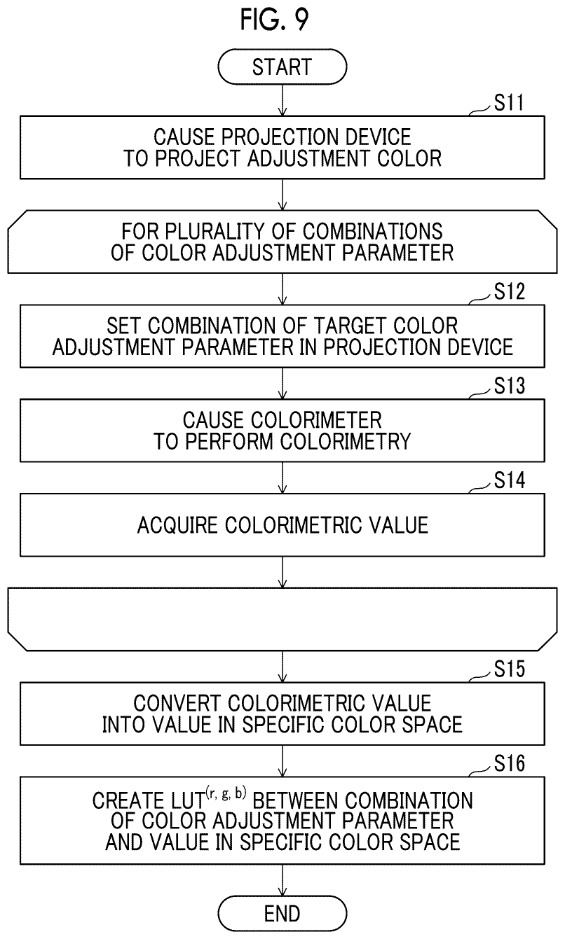

FIG. 9 is a flowchart showing a generation process of the look-up table by the processor 51 of the computer 50.

The processor 51 causes the first projection device 10a to project the test pattern I (r, g, b) of the adjustment color toward the projection object 6 (step S11). In the present example, as described above, the white test pattern I (r, g, b=255) is projected.

The processor 51 sequentially projects the test pattern I (r, g, b) for a plurality of combinations in which the color adjustment parameter P (p1, p2, p3) is changed for white. As described above, p1 is the gain of R, p2 is the gain of G, and p3 is the gain of B.

The processor 51 sets the combination of the target color adjustment parameter P in the first projection device 10a and causes the first projection device 10a to project the test pattern I (r, g, b) (step S12).

Next, the processor 51 causes the colorimeter 131 to perform colorimetry of the XYZ value (XYZ^{(r, g, b=255)} (p1, p2, p3)) corresponding to the white test pattern I projected onto the projection object 6 (step S13). In this case, the processor 51 may output, for example, a guide such as “Please perform colorimetry” or may control the colorimeter 131 to perform colorimetry.

Next, the processor 51 acquires the colorimetric value of the XYZ value (XYZ^{(r, g, b=255)} (p1, p2, p3)) corresponding to the white test pattern I from the colorimeter 131 (step S14).

Next, the processor 51 converts the colorimetric value of each XYZ value in which the color adjustment parameter P of white is changed into a value in the specific color space (in the present example, the Lab color space 61) (step S15).

Next, the processor 51 creates a white adjustment look-up table^{(r, g, b=255)} indicating a relationship between the plurality of combinations of the color adjustment parameter P and the value in the Lab color space 61 (step S16).

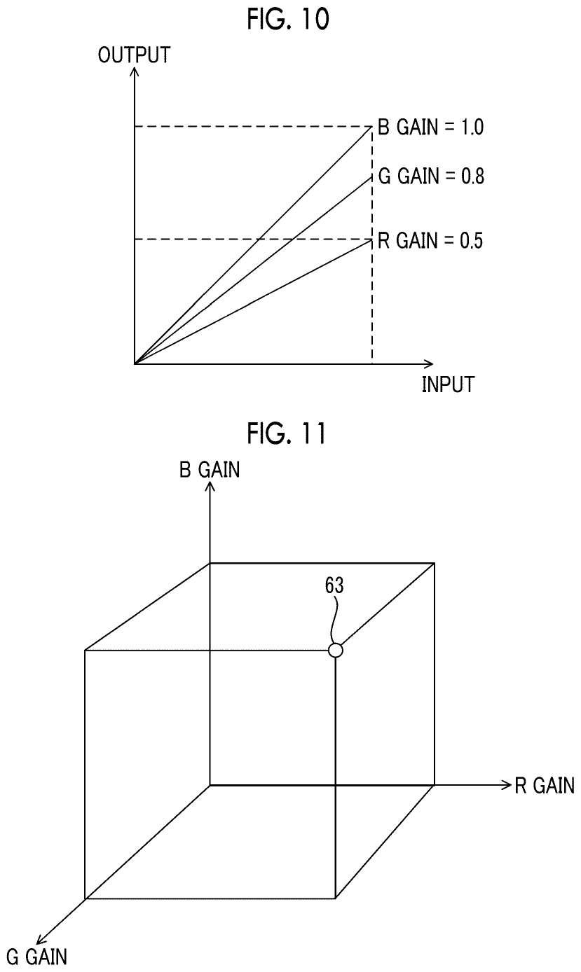

FIG. 10 is a diagram showing an example of the color adjustment parameter P (p1, p2, p3). As shown in FIG. 10, the color adjustment parameter P (p1, p2, p3) is, for example, a parameter for performing gain adjustment for each of R, G, and B, and the output also continuously changes in response to the increase or decrease of the parameter. As described above, the R gain is p1, the G gain is p2, and the B gain is p3. For convenience of description, FIG. 10 shows that the input and output are linear.

In a case where the processor 51 changes the color adjustment parameter P (p1, p2, p3) and performs colorimetry of the XYZ value, for example, the colorimetry is performed for a plurality of combinations in which the R gain value (p1), the G gain value (p2), and the B gain value (p3) are changed from 1.0 to 0.5 in increments of 0.02. The XYZ value of the reference white described above is the colorimetric value of the color adjustment parameter P (p1, p2, p3) in a case where all of the R, G, and B gain values are set to 1.0. Here, the color adjustment parameter P (p1, p2, p3) is changed in increments of 0.02 and colorimetry is performed, but the colorimetric value in between can be calculated by, for example, interpolation using a colorimetric value in the vicinity.

FIG. 11 is a diagram showing an example of the look-up table in a case where the adjustment color is white. As described above, the look-up table (LUT) is a three-dimensional table indicating a relationship between the color adjustment parameter P (p1, p2, p3) and the position in the Lab color space.

The look-up table in a case where the adjustment color is white is denoted by LUT^{white}=LUT^{(255, 255, 255)}. In addition, the relationship between the color adjustment parameter P (p1, p2, p3) and the position in the Lab color space is denoted by (L*, a*, b*)=LUT^{(r, g, b)}(p1, p2, p3). Therefore, the relationship between the color adjustment parameter P (p1, p2, p3) and the position in the Lab color space in a case where the adjustment color is white is displayed as (L*, a*, b*)=LUT^{(255, 255, 255)} (R gain, G gain, B gain).

Since the gain values of the color adjustment parameter P (p1, p2, p3) in the reference white having the maximum luminance are R, G, B gain=1.0, in a case where the position of the reference white in the Lab color space is (L*, a*, b*)=(100, 0, 0), the relationship is (100, 0, 0)=LUT^{(255, 255, 255)}(1.0, 1.0, 1.0). In addition, the relationship is set as a spatial position 63 in the three-dimensional look-up table shown in FIG. 11.

### <Color Adjustment of Projection Device Using Look-Up Table>

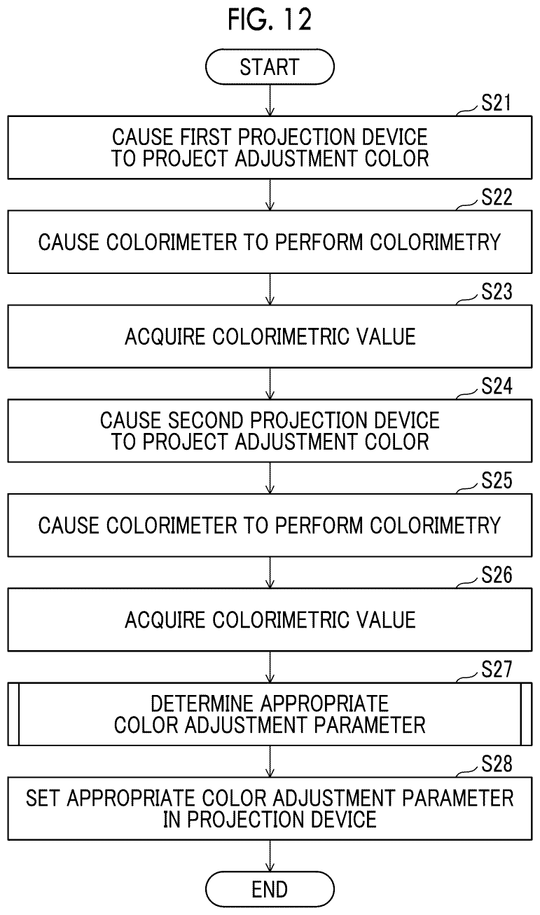

The color adjustment between the projection of the first projection device 10a and the projection of the second projection device 10b using the look-up table for color adjustment will be described with reference to FIGS. 12 to 15.

FIG. 12 is a flowchart showing a color adjustment process using the look-up table by the processor 51 of the computer 50.

First, the processor 51 causes the first projection device 10a to project the test pattern I (r, g, b) of the adjustment color toward the projection object 6 (step S21). In the present example, a case where the white is adjusted between the projection of the first projection device 10a and the projection of the second projection device 10b using the white adjustment look-up table created as described above will be described. Therefore, in step S21, the processor 51 causes the first projection device 10a to project the white test pattern I (r, g, b=255). The processor 51 controls the second projection device 10b such that the light is not projected while the first projection device 10a is performing the projection.

Next, the processor 51 causes the colorimeter 131 to perform colorimetry of the XYZ value (XYZ^{white}_{PJ1}(p1, p2, p3)) corresponding to the white test pattern I projected onto the projection object 6 (step S22). In this case, the processor 51 may output, for example, a guide such as “Please perform colorimetry” or may control the colorimeter 131 to perform colorimetry. The colorimetric value of white is denoted by “XYZ^{white}”, and the colorimetric value of the first projection device 10a is denoted by “XYZ_{PJ1}”.

Next, the processor 51 acquires the XYZ value (XYZ^{white}_{PJ1} (p1, p2, p3)) corresponding to the white test pattern I from the colorimeter 131 (step S23).

Next, as in the case of the first projection device 10a, the processor 51 causes the second projection device 10b to project the white test pattern I (r, g, b=255) toward the projection object 6 (step S24). The processor 51 controls the first projection device 10a such that the light is not projected in this case.

Next, the processor 51 causes the colorimeter 131 to perform colorimetry of the XYZ value (XYZ^{white}_{PJ2}(p1, p2, p3)) corresponding to the white test pattern I projected onto the projection object 6 (step S25). The colorimetric value of the second projection device 10b is denoted by “XYZ_{PJ2}”. In this case, the processor 51 may output, for example, a guide such as “Please perform colorimetry” or may control the colorimeter 131 to perform colorimetry.

Next, the processor 51 acquires the XYZ value (XYZ^{white}_{PJ2}(p1, p2, p3)) corresponding to the white test pattern I from the colorimeter 131 (step S26).

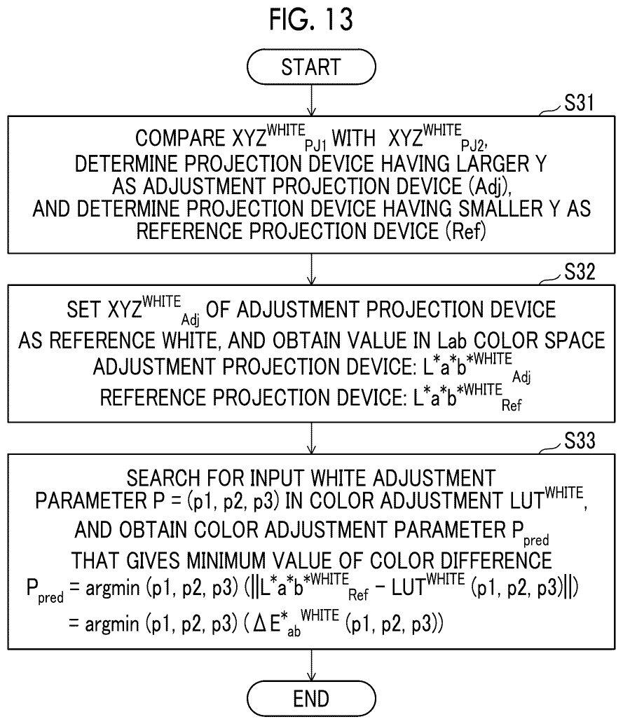

Next, the processor 51 performs a determination process of an appropriate color adjustment parameter for matching (bringing close) the white of the first projection device 10a and the white of the second projection device 10b (step S27). The determination process will be described with reference to a flowchart of FIG. 13.

Next, the processor 51 sets the appropriate color adjustment parameter determined in the determination process of step S27 in the adjustment projection device (any one of the first projection device 10a or the second projection device 10b) determined in the determination process of step S27 (step S28), and ends the color adjustment process.

FIG. 13 is a flowchart showing a determination process of the color adjustment parameter by the processor 51. The determination process of the color adjustment parameter is the process of step S27 in FIG. 12.

The processor 51 compares the XYZ^{white}_{PJ1}(p1, p2, p3) of the first projection device 10a measured in step S22 with the XYZ^{white}_{PJ2}(p1, p2, p3) of the second projection device 10b measured in step S25, determines the projection device having a larger Y (luminance) as an adjustment projection device (Adj) for adjusting the color, and determines the projection device having a smaller Y as a reference projection device (Ref) for not adjusting the color (step S31).

Next, the processor 51 sets the XYZ^{white}_{Adj}, which is the colorimetric value of white of the adjustment projection device, as the reference white, obtains the value (L*a*b*^{white}_{Adj}) of the adjustment projection device in the Lab color space from the colorimetric value (XYZ^{white}_{Adj}) of the adjustment projection device, and obtains the value (L*a*b*^{white}_{Ref}) of the reference projection device in the Lab color space from the colorimetric value (XYZ^{white}_{Ref}) of the reference projection device (step S32). The colorimetric value of the adjustment projection device (Adj) is denoted by “XYZ_{Adj}”, and the value in the Lab color space is denoted by “L*a*b*_{Adj}”. In addition, the colorimetric value of the reference projection device (Ref) is denoted by “XYZ_{Ref}”, and the value in the Lab color space is denoted by “L*a*b*_{Ref}”.

Next, the processor 51 searches for the input white adjustment parameter P (p1, p2, p3) in the white adjustment look-up table^{(r, g, b=255)} created in step S16 of FIG. 9, and obtains the color adjustment parameter P_{pred} that gives a minimum value of a color difference (ΔE) with the L*a*b*^{white}_{Ref} value of the reference projection device (step S33). P_{pred} is obtained by the following expression (1).

P_{pred}=argmin(p1,p2,p3)(∥L*a*b*^{white}_{Ref}−LUT^{white}(p1,p2,p3)∥)=argmin(p1,p2,p3)(ΔE*_{ab}^{white}(p1,p2,p3)) (1)

The color adjustment parameter P_{pred} is a color adjustment parameter for bringing the position of the colorimetric value (XYZ^{white}_{Adj}) of the adjustment projection device in the Lab color space closer to the position of the colorimetric value (XYZ^{white}_{Ref}) of the reference projection device in the Lab color space. The position in the Lab color space (specific color space) is, for example, each of the values of L*, a*, and b*. Bringing closer means reducing the distance in the Lab color space before the application of the color adjustment parameter. The color adjustment parameter P_{pred} is an example of a “first color adjustment parameter” in the present invention.

The look-up table in the present embodiment is standardized by L* of luminance (brightness). Therefore, the projection distance from the first projection device 10a to the projection object 6 in a case of generating the look-up table (FIG. 7) may be different from the projection distance in a case of applying the generated look-up table (FIG. 1).

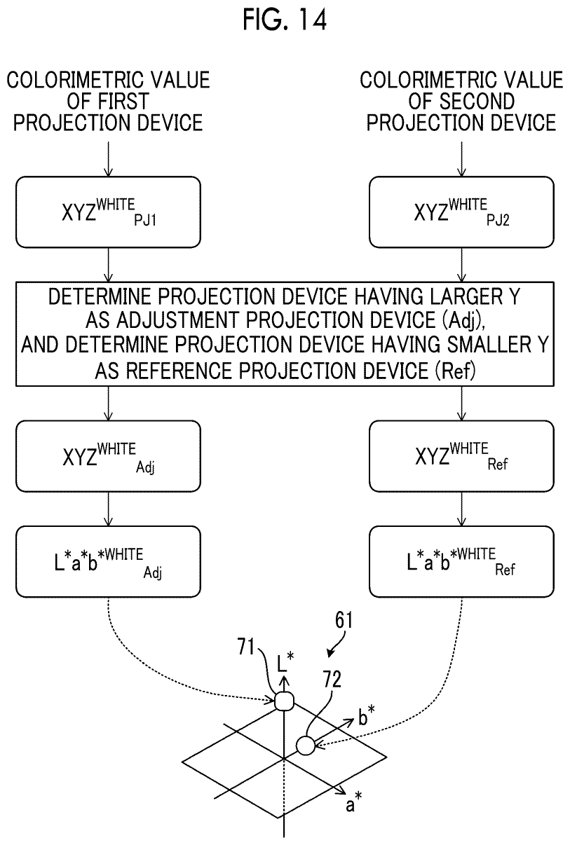

FIG. 14 is a diagram showing setting of the position in the Lab color space in the determination process of the color adjustment parameter.

As shown in FIG. 14, the processor 51 sets the colorimetric value of the first projection device 10a to XYZ^{white}_{PJ1}(p1, p2, p3). In addition, the processor 51 sets the colorimetric value of the second projection device 10b to XYZ^{white}_{PJ2}(p1, p2, p3). The processor 51 compares XYZ^{white}_{PJ1}(p1, p2, p3) and XYZ^{white}_{PJ2}(p1, p2, p3), determines the projection device having a larger Y (luminance) as an adjustment projection device (Adj) for adjusting the color of the test pattern I, and determines the projection device having a smaller Y as a reference projection device (Ref) for not adjusting the color of the test pattern I. This corresponds to the process of step S31 in FIG. 13.

In the present example, it is assumed that the Y of the XYZ^{white}_{PJ1}(p1, p2, p3) of the first projection device 10a is larger than the Y of the XYZ^{white}_{PJ2}(p1, p2, p3) of the second projection device 10b. Therefore, the processor 51 determines the first projection device 10a as the adjustment projection device (Adj). In addition, the processor 51 determines the second projection device 10b as the reference projection device (Ref).

Next, the processor 51 sets the colorimetric value of the adjustment projection device (Adj) to XYZ^{white}_{Adj}(p1, p2, p3). In addition, the processor 51 sets the colorimetric value of the reference projection device (Ref) to XYZ^{white}_{Ref}(p1, p2, p3).

Next, the processor 51 obtains the value (L*a*b*^{white}_{Adj}) of the adjustment projection device in the Lab color space from the colorimetric value (XYZ^{white}_{Adj}) of the adjustment projection device. In addition, the processor 51 obtains the value (L*a*b*^{white}_{Ref}) of the reference projection device in the Lab color space from the colorimetric value (XYZ^{white}_{Ref}) of the reference projection device. In this case, the colorimetric value (XYZ^{white}_{Adj}) of white of the adjustment projection device is set as the reference white. Therefore, the value (L*a*b*^{white}_{Adj}) of the adjustment projection device in the Lab color space is (100, 0, 0). This corresponds to the process of step S32 in FIG. 13.

The brightness based on XYZ^{white}_{PJ1}(p1, p2, p3) is brighter than the brightness based on XYZ^{white}_{PJ2}(p1, p2, p3). The brightness is “L*”. The projection device having a higher L* based on the colorimetric value among the first projection device 10a and the second projection device 10b is the adjustment projection device, and the projection device having a lower L* based on the colorimetric value is the reference projection device. The colorimetric value (XYZ^{white}_{PJ1}) of the first projection device 10a is an example of a “first colorimetric value” of the present invention. The colorimetric value (XYZ^{white}_{PJ2}) of the second projection device 10b is an example of a “second colorimetric value” of the present invention.

As shown in FIG. 14, in the Lab color space 61, the L*a*b*^{white}_{Adj} value of the adjustment projection device (first projection device 10a) is determined at a spatial position 71, and the L*a*b*^{white}_{Ref} value of the reference projection device (second projection device 10b) is determined at a spatial position 72. The spatial position 71 is L*a*b*^{white}_{Adj} value=(100, 0, 0). As the spatial position 71 of the L*a*b*^{white}_{Adj} value and the spatial position 72 of the L*a*b*^{white}_{Ref} value are closer to each other, the colors of the projection of the first projection device 10a and the projection of the second projection device 10b are closer to each other.

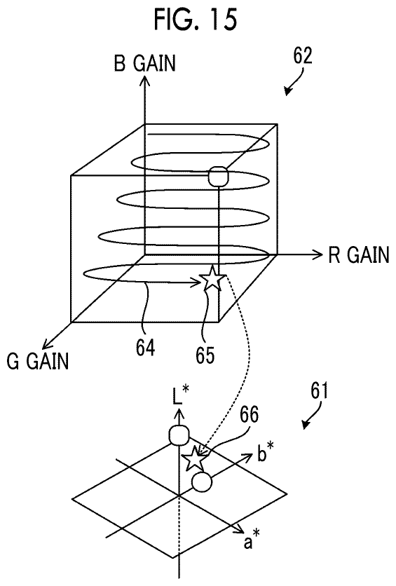

FIG. 15 is a diagram showing determination of the color adjustment parameter in the determination process of the color adjustment parameter. As shown in FIG. 15, the processor 51 performs a full search of the white adjustment parameter P (p1, p2, p3) for the white adjustment look-up table^{(r, g, b=255)} 62, for example, along a search path 64.

The processor 51 determines a color adjustment parameter P_{pred}65 based on a color difference that is a difference between a position of a colorimetric value (XYZ^{white}_{Adj}) in the Lab color space 61 obtained in a case of being applied to the projection of white by the adjustment projection device and a position of a colorimetric value (XYZ^{white}_{Ref}) in the Lab color space 61 obtained by the projection of white by the reference projection device.

The processor 51 determines a color adjustment parameter having a minimum color difference among the color adjustment parameters of the look-up table^{(r, g, b=255)} 62 as the color adjustment parameter P_{pred} 65. Specifically, the processor 51 determines the color adjustment parameter P_{pred} 65 at which a distance between the position of the L*a*b*^{white}_{Adj} value of the adjustment projection device and the position of the L*a*b*^{white}_{Ref} value of the reference projection device is minimized.

The processor 51 sets the determined color adjustment parameter P_{pred} 65 in the adjustment projection device (first projection device 10a) and causes the adjustment projection device to project the test pattern I. In a case where the XYZ^{(r, g, b=255)} value corresponding to the test pattern I is converted into a value in the Lab color space 61, the position of the L*a*b*^{white}_{PJ1} value of the first projection device 10a is determined at a spatial position 66.

As described above, the computer 50 of the present embodiment determines the color adjustment parameter P_{pred} for bringing the position of the colorimetric value (XYZ^{white}_{PJ1}) having a high luminance in the Lab color space closer to the position of the colorimetric value (XYZ^{white}_{PJ2}) having a low luminance in the Lab color space based on the look-up table created in advance as information indicating the relationship between the color adjustment parameter P and the position in the Lab color space, the colorimetric value (XYZ^{white}_{PJ1}) of the first projection device 10a, and the colorimetric value (XYZ^{white}_{PJ2}) of the second projection device 10b. According to this configuration, since the color adjustment is performed by using the look-up table in which the relative color movement based on the color adjustment parameter of the projection device 10 is recorded, the color adjustment can be performed in a short time and accurately.

### <Modification Example of Color Adjustment Using Look-Up Table>

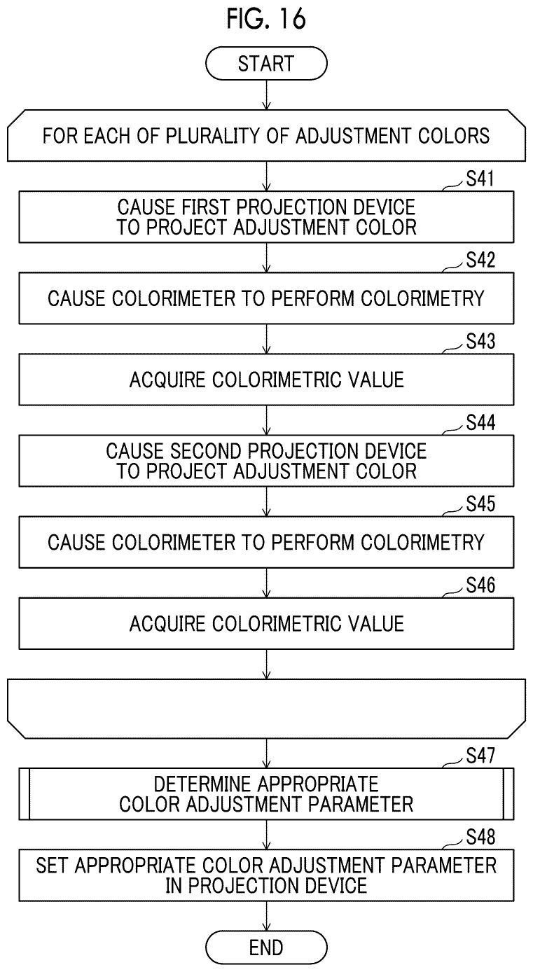

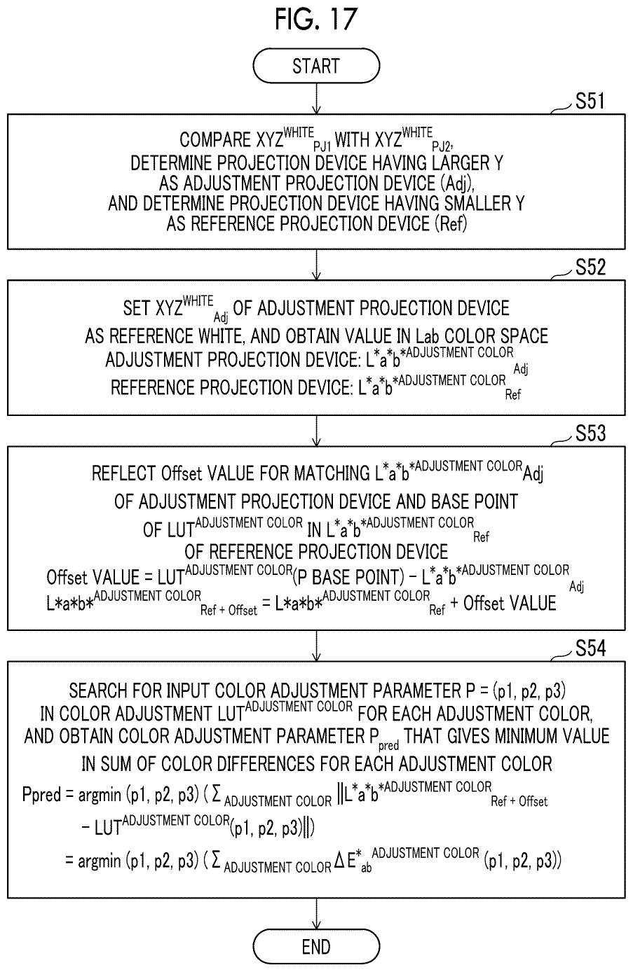

A modification example of the color adjustment between the projection of the first projection device 10a and the projection of the second projection device 10b using the look-up table for color adjustment will be described with reference to FIGS. 16 and 17.

FIG. 16 is a flowchart showing a modification example of the color adjustment process using the look-up table by the processor 51. In the color adjustment process in FIG. 12, a case where only white is adjusted has been described. However, due to the configuration inside the projection device, there are colors that are difficult to control color generation and are likely to deviate, such as a combination of a light source and a color wheel, and a specific representative color used in each video, and there is a case where color adjustment is desired other than white. Therefore, in the present modification example, a case where a plurality of colors are adjusted will be described.

First, the processor 51 creates a look-up table (r, g, b) for color adjustment indicating a relationship between a plurality of combinations of the color adjustment parameter P and a value in the Lab color space 61 for an adjustment color other than white in the same manner as in FIGS. 7 to 11. For example, in a case where the adjustment color is cyan, the look-up table is a look-up table^{(r, g, b=0, 255, 255)}, and in a case where the adjustment color is magenta, the look-up table is a look-up table^{(r, g, b=255, 0, 255)}.

Next, as shown in FIG. 16, the processor 51 performs the processes of steps S41 to S46 for each of a plurality of adjustment colors. The plurality of adjustment colors may include, for example, cyan and magenta in addition to white. The processes of steps S41 to S46 are the same as the processes of steps S21 to S26 described in FIG. 12, and thus the description thereof will be omitted.

Next, the processor 51 performs a determination process of an appropriate color adjustment parameter for matching (bringing close) the colors of the first projection device 10a and the second projection device 10b based on the information acquired in steps S41 to S46 (step S47). The determination process will be described with reference to a flowchart of FIG. 17.

Next, the processor 51 sets the appropriate color adjustment parameter determined in the determination process of step S47 in the adjustment projection device (any one of the first projection device 10a or the second projection device 10b) determined in the determination process of step S47 (step S48).

FIG. 17 is a flowchart showing a modification example of the determination process of the color adjustment parameter by the processor 51. The determination process of the color adjustment parameter is the process of step S47 in FIG. 16.

The processor 51 compares the XYZ^{white}_{PJ1}(p1, p2, p3) of the first projection device 10a measured in step S42 with the XYZ^{white}_{PJ2}(p1, p2, p3) of the second projection device 10b measured in step S45, determines the projection device having a larger Y (luminance) as an adjustment projection device (Adj) for adjusting the color, and determines the projection device having a smaller Y as a reference projection device (Ref) for not adjusting the color (step S51).

Next, the processor 51 sets the XYZ^{white}_{Adj}, which is the colorimetric value of white of the adjustment projection device, as the reference white, obtains the value (L*a*b*^{adjustment color}_{Adj}) of the adjustment projection device in the Lab color space from the colorimetric value (XYZ^{adjustment color}_{Adj}) of the adjustment projection device for each adjustment color, and obtains the value (L*a*b*^{adjustment color}_{Ref}) of the reference projection device in the Lab color space from the colorimetric value (XYZ^{adjustment color}_{Ref}) of the reference projection device (step S52). The colorimetric value of each adjustment color is denoted by “XYZ^{adjustment color}” The value of each adjustment color in the Lab color space is denoted by “L*a*b*^{adjustment color}”.

Next, the processor 51 reflects an Offset value for matching a base point of the L*a*b*^{adjustment color}_{Adj} value in the look-up table for the adjustment color in the value (L*a*b*^{adjustment color}_{Adj}) of the adjustment projection device in the Lab color space obtained in step S52 in the value (L*a*b*^{adjustment color}_{Ref}) of the reference projection device in the Lab color space (step S53).

In a case where the adjustment color is white, since the base point of the L*a*b*^{white}_{Adj} value is (100, 0, 0), no special process for matching the base point is required. However, in a case of the other (other than white) adjustment color, a slight deviation may occur between the base point of the L*a*b*^{adjustment color}_{Adj} value of the adjustment projection device and the base point of the L*a*b*^{adjustment color}_{Adj} value expected in the look-up table for the adjustment color due to a measurement error or the like.

The processor 51 calculates the deviation as an Offset value, and performs a correction process of reducing the deviation of the base point by reflecting the Offset value in the value (L*a*b*^{adjustment color}_{Ref}) of the reference projection device for comparison with the look-up table. The Offset value and the L*a*b*^{adjustment color}_{Ref+Offset} value in which the Offset value is reflected are obtained by the following expression (2).

Offset value=LUT^{adjustment color}(P base point)−L*a*b*^{adjustment color}_{Adj}

L*a*b*^{adjustment color}_{Ref+Offset}=L*a*b*^{adjustment color}_{Ref}+Offset value (2)

The P base point is, for example, a base point in a case where the R, G, and B gain values are 1.0. The output value of the look-up table can also be corrected, but since the processing load is high in a case of being applied to the entire look-up table, the value (L*a*b*^{adjustment color}_{Ref}) of the reference projection device is corrected.

Next, the processor 51 searches for the input color adjustment parameter P (p1, p2, p3) in the look-up table^{(r, g, b)} for color adjustment for each adjustment color, and obtains the color adjustment parameter P_{pred} that gives a minimum value in a sum of color differences with the L*a*b*^{adjustment color}_{Ref+Offset} value of the reference projection device in which the Offset value for each adjustment color is reflected (step S54). P_{pred} is obtained by the following expression (3).

P_{pred}=argmin(p1,p2,p3)(Σ_{adjustment color}∥L*a*b*^{adjustment color}_{Ref+Offset}−LUT^{adjustment color}(p1,p2,p3)∥)=argmin(p1,p2,p3)(Σ_{adjustment color}ΔE*_{ab}^{adjustment color}(p1,p2,p3)) (3)

Specifically, in step S54, the processor 51 determines the color adjustment parameter P_{pred} based on the look-up table^{(r, g, b=255)} for adjusting white, the look-up table^{(r, g, b)} for adjusting the adjustment color, the colorimetric value (XYZ^{white}_{PJ1}), the colorimetric value (XYZ^{white}_{PJ2}), the colorimetric value (XYZ^{adjustment color}_{PJ1}), and the colorimetric value (XYZ^{adjustment color}_{PJ2}).

The processor 51 obtains a first color difference that is a difference between a position of a colorimetric value (XYZ^{white}_{Adj}) in the Lab color space 61 obtained in a case of being applied to the projection of white by the adjustment projection device and a position of a colorimetric value (XYZ^{white}_{Ref}) in the Lab color space 61 obtained by the projection of white by the reference projection device. In addition, the processor 51 obtains a second color difference that is a difference between a position of a colorimetric value (XYZ^{adjustment color}_{Adj}) in the Lab color space 61 obtained in a case of being applied to the projection of the adjustment color performed by the adjustment projection device and a position of a colorimetric value (XYZ^{adjustment color}_{Ref}) in the Lab color space 61 obtained by the projection of the adjustment color performed by the reference projection device.

Then, the processor 51 determines the color adjustment parameter P_{pred} based on the addition result of the first color difference and the second color difference. The processor 51 determines the color adjustment parameter at which the addition result of the first color difference and the second color difference is minimized among the color adjustment parameters of the look-up table^{(r, g, b)} for each adjustment color (for example, white, cyan, magenta, and the like) as the color adjustment parameter P_{pred}. The colorimetric value (XYZ^{adjustment color}_{PJ1}) of the first projection device 10a is an example of a “third colorimetric value” of the present invention. The colorimetric value (XYZ^{adjustment color}_{PJ2}) of the second projection device 10b is an example of a “fourth colorimetric value” of the present invention. The adjustment color in XYZ^{adjustment color} is, for example, cyan or magenta.

The processor 51 may perform weighted addition of the color differences in a case of adding the first color difference and the second color difference. That is, in a case of determining the color adjustment parameter P_{pred}, the processor 51 may consider, for example, a priority of the color in the image content to be projected and may perform weighting for each adjustment color to determine the color adjustment parameter P_{pred}.

As described above, even in a case of performing the adjustment with a plurality of colors, the color adjustment can be performed in a short time and accurately by using the look-up table for each adjustment color in which the relative color movement based on the color adjustment parameter of the projection device 10 is recorded.

### <Setting of Adjustment Projection Device (Adj) and Reference Projection Device (Ref)>

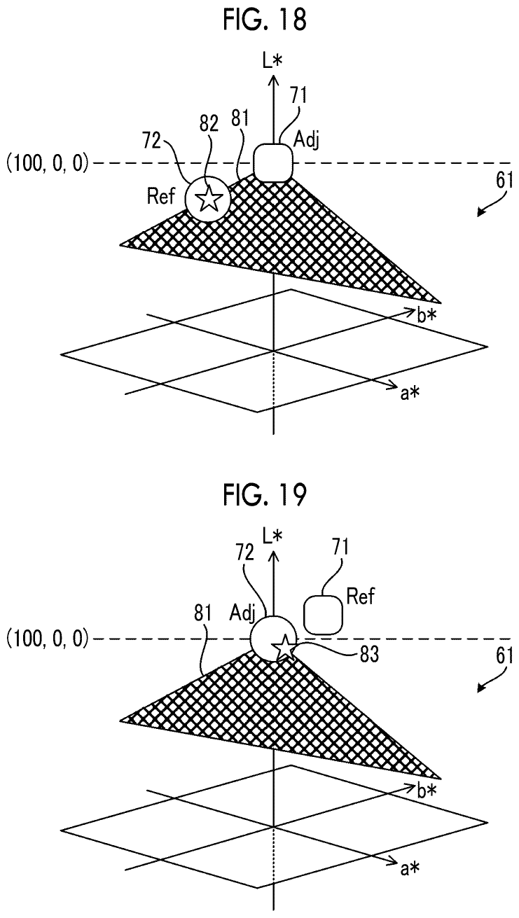

FIG. 18 is a diagram showing an example of setting a projection device having a large Y (luminance) as an adjustment projection device (Adj). In a case where the projection device having a large Y is set as the adjustment projection device, as shown in FIG. 18, in the Lab color space 61, the L*a*b*^{white}_{Adj} value of the adjustment projection device is determined at, for example, a spatial position 71.

Then, the L*a*b*^{white}_{Ref} value of the reference projection device that is the projection device having a small Y is determined at, for example, a spatial position 72. Here, in a case where the XYZ value of white of the adjustment projection device is set as the reference white, the spatial position 71 is L*a*b*^{white}_{Adj} value=(100, 0, 0).

In this case, the Y of the adjustment projection device (Adj) is reduced to match the Y of the adjustment projection device (Adj) with the Y of the reference projection device (Ref). In this case, a color adjustment parameter 82 (star mark) in a look-up table^{(r, g, b=255)} 81 is determined as the color adjustment parameter P_{pred} that brings the position (spatial position 71) of the L*a*b*^{white}_{Adj} value of the adjustment projection device closest to the position (spatial position 72) of the L*a*b*^{white}_{Ref} value of the reference projection device (minimum color difference).

Then, by applying the determined color adjustment parameter 82 to the adjustment projection device (Adj), the position indicating the L*a*b*^{white}_{Adj} value of the adjustment projection device is closest to the position (minimum color difference) of the L*a*b*^{white}_{Ref} value of the reference projection device (spatial position 72).

FIG. 19 is a diagram showing an example of setting a projection device having a small Y (luminance) as an adjustment projection device (Adj). In a case where the projection device having a small Y is set as the adjustment projection device, as shown in FIG. 19, in the Lab color space 61, the L*a*b*^{white}_{Adj} value of the adjustment projection device is determined at, for example, a spatial position 72.

Then, the L*a*b*^{white}_{Ref} value of the reference projection device that is the projection device having a large Y is determined at, for example, a spatial position 71. Here, in a case where the XYZ value of white of the adjustment projection device is set as the reference white, the spatial position 72 is L*a*b*^{white}_{Adj} value=(100, 0, 0).

In this case, the adjustment projection device (Adj) having a small Y is adjusted to be close to the position (spatial position 71) of the L*a*b*^{white}_{Ref} value of the reference projection device (Ref) having a large Y. In this case, a color adjustment parameter 83 (star mark) in a look-up table^{(r, g, b=255)} 81 is determined as the color adjustment parameter P_{pred} that brings the position (spatial position 72) of the L*a*b*white Adj value of the adjustment projection device closest to the position (spatial position 71) of the L*a*b*^{white}_{Ref} value of the reference projection device (minimum color difference).

Then, by applying the determined color adjustment parameter 83 to the adjustment projection device (Adj), the position indicating the L*a*b*^{white}_{Adj} value of the adjustment projection device is closest to the position (minimum color difference) of the L*a*b*^{white}_{Ref} value of the reference projection device (spatial position 71).

In the color adjustment of the plurality of projection devices 10, there is a case where the adjustment is not desired to be performed such that the luminance of the projection device having a large luminance is reduced (darkened) to match the projection device having a small luminance. In addition, the user may determine the projection device to be used as the adjustment reference depending on the disposition status of the plurality of projection devices. Therefore, by allowing the user to select the projection device to be the adjustment projection device and the projection device to be the reference projection device, the color adjustment of the projection device can be performed in accordance with the intention of the user.

### <Determination of Color Adjustment Parameter Using Chromaticity Difference>

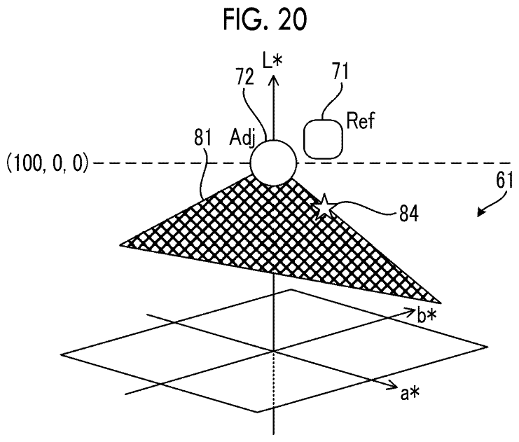

FIG. 20 is a diagram showing an example of determining the color adjustment parameter based on the chromaticity difference. In the example described above, a case where the color adjustment parameter P_{pred} that gives a minimum value of the color difference (ΔE*_{ab}) with the L*a*b* value of the reference projection device is determined by searching for the input parameter in the look-up table has been described, but the present invention is not limited to this. For example, the color adjustment parameter P_{pred} that gives a minimum value of the chromaticity difference (Δa*b*) may be determined.

For example, as shown in FIG. 20, in a case where the projection device having a small Y is set as the adjustment projection device (Adj), the color adjustment parameter P_{pred} that brings the position (spatial position 72) of the L*a*b*white Adj value of the adjustment projection device closest to the position (spatial position 71) of the L*a*b*^{white}_{Ref} value of the reference projection device (minimum chromaticity difference) is determined.

In this case, a color adjustment parameter 84 (star mark) in a look-up table^{(r, g, b=255)} 81 is determined as the color adjustment parameter P_{pred} that gives the minimum chromaticity difference. Then, by applying the determined color adjustment parameter 84 to the adjustment projection device (Adj), the position indicating the L*a*b*^{white}_{Adj} value of the adjustment projection device is closest to the position (minimum chromaticity difference) of the L*a*b*^{white}_{Ref} value of the reference projection device (spatial position 71).

As described above, by using the chromaticity difference (Aa*b*) in a case of determining the color adjustment parameter P_{pred}, the color adjustment of the projection device can be performed in accordance with the intention of the user.

### <Correction of Colorimetric Value in Case of Presence of Disturbance Light>

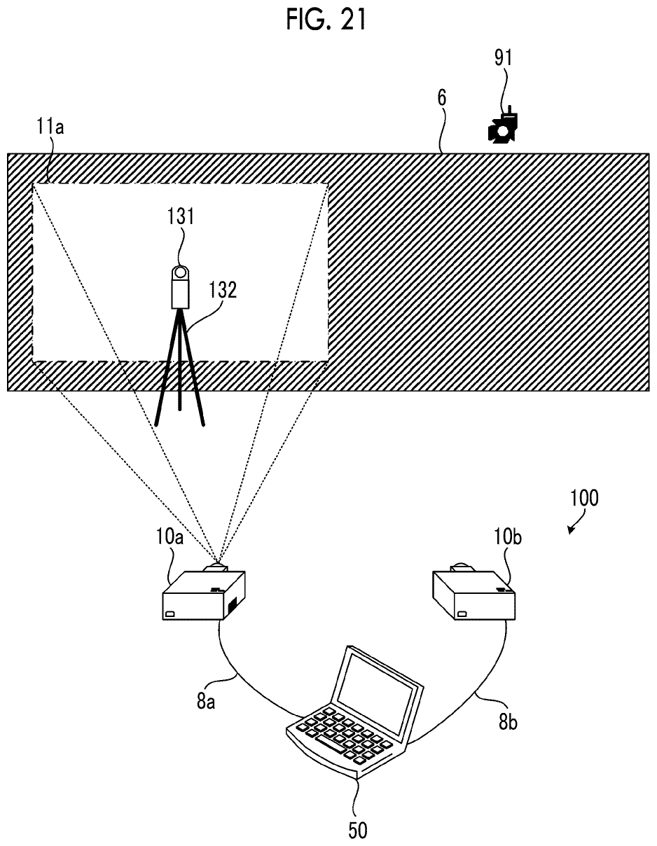

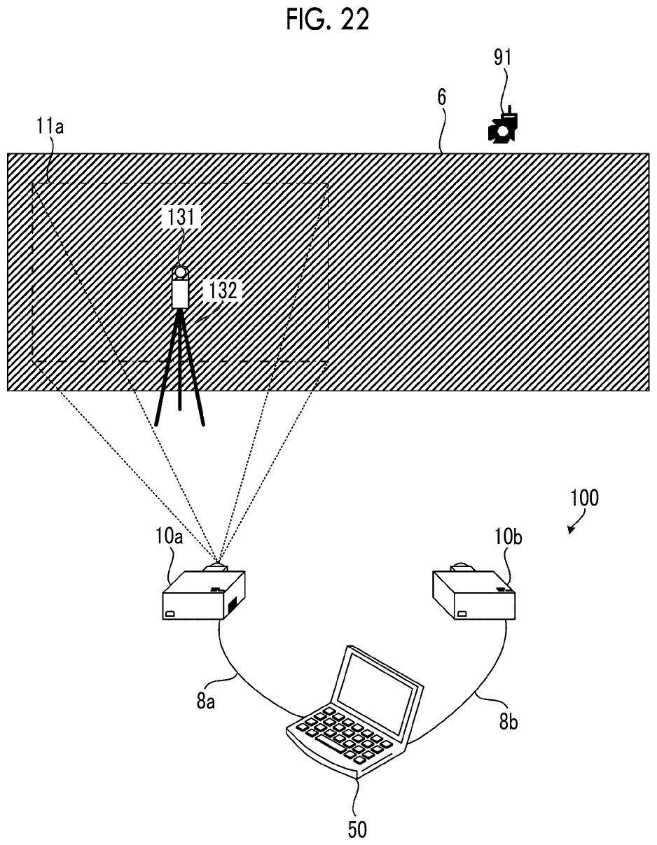

The correction of the colorimetric value in a case where the disturbance light is present during the color adjustment of the first projection device 10a and the second projection device 10b will be described with reference to FIGS. 21 and 22. FIG. 21 is a diagram showing an example of color adjustment in an environment in which disturbance light is present. FIG. 22 is a diagram showing an example of colorimetry of the disturbance light in an environment in which only the disturbance light is present.

The generation of the look-up table for color adjustment described in FIG. 7 is assumed to be performed in an environment in which there is no disturbance light during the colorimetry of the image. Therefore, in the color adjustment process using the look-up table described in FIGS. 1 and 12, the color adjustment process in an environment in which there is no disturbance light is required. However, in an actual installation site of the projection system 100, for example, as shown in FIG. 21, it may be difficult to reproduce the environment in which there is no disturbance light during the color adjustment because work light 91 or the like is provided.

Therefore, in this case, as shown in FIG. 22, the colorimetric value of the disturbance light in the environment in which only the work light 91 (disturbance light) is present is measured in advance. Then, in a case of acquiring the colorimetric value in step S23 and step S26 of the color adjustment process in FIG. 12, the color adjustment process using the look-up table is performed after subtracting the disturbance light colorimetric value from the colorimetric value of the colorimeter 131.

Therefore, the colorimetric value (XYZ^{white}_{PJ1}) of the first projection device 10a in the color adjustment of the first projection device 10a and the second projection device 10b is a value obtained by subtracting the colorimetric value of the first projection device 10a in a non-projection state from the colorimetric value of the light projected from the first projection device 10a in white, for example. In addition, the colorimetric value (XYZ^{white}_{PJ2}) of the second projection device 10b is a value obtained by subtracting the colorimetric value of the second projection device 10b in a non-projection state from the colorimetric value of the light projected from the second projection device 10b in white, for example. The non-projection state is, for example, an environment in which the first projection device 10a and the second projection device 10b are not projected and only the work light 91 (disturbance light) is emitted.

As described above, in the color adjustment of the projection device 10, since the influence of the disturbance light during the colorimetry can be eliminated, the color adjustment can be performed more accurately.

### <Guide for Colorimetry Position>

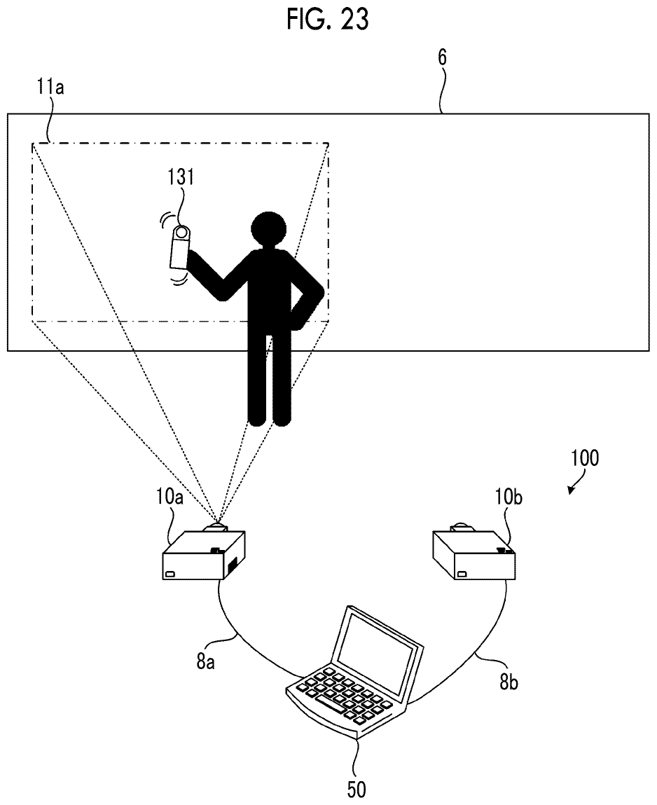

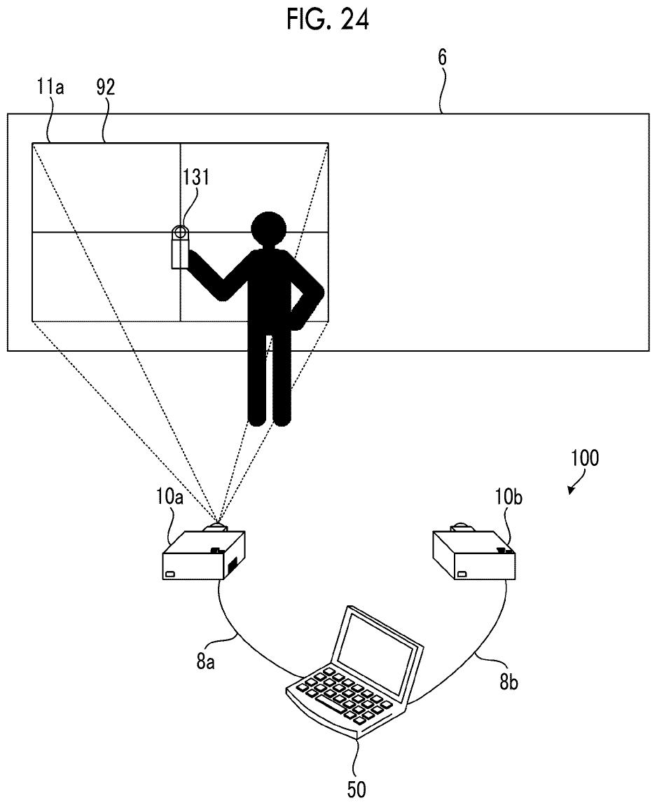

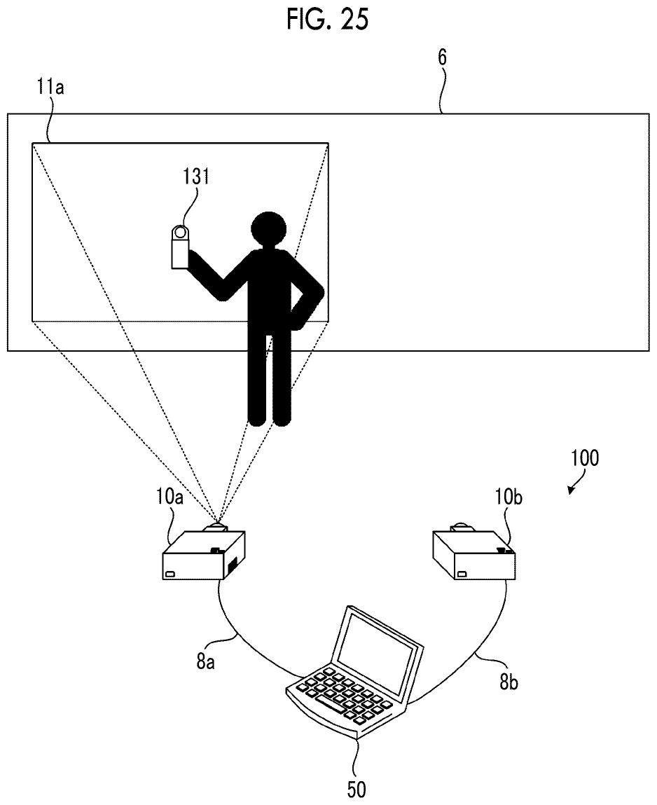

The guide for the position at which the colorimetric value is measured in a case of performing the color adjustment of the projection device 10 will be described with reference to FIGS. 23 to 25. FIG. 23 is a diagram showing an example of a state in which a colorimetry position is not stable during colorimetry. FIG. 24 is a diagram showing an example of a guide line 92 that guides the colorimetry position. FIG. 25 is a diagram showing a state in which the guide line 92 shown in FIG. 24 disappears.

In a case of performing the color adjustment of the first projection device 10a and the second projection device 10b, in order to acquire the accurate colorimetric value in each projection device, it is desirable not to change the colorimetry position in each projection range 11a, 11b during the colorimetry. In addition, in a case of measuring the plurality of adjustment colors, it is desirable to set the measurement position to the same position between the adjustment colors.

In this case, in the acquisition of the colorimetric value (XYZ^{white}_{PJ1}) of the first projection device 10a, the processor 51 causes the first projection device 10a to project an image of the guide line 92 that guides the position of the colorimeter 131 that measures the light projected from the first projection device 10a. In addition, in the acquisition of the colorimetric value (XYZ^{white}_{PJ2}) of the second projection device 10b, the processor 51 causes the second projection device 10b to project an image of the guide line 92 that guides the position of the colorimeter 131 that measures the light projected from the second projection device 10b.

For example, as shown in FIG. 23, in a case of measuring the colorimetric value of the test pattern (for example, a white pattern) projected from the first projection device 10a to the projection range 11a of the projection object 6, in a case where the position of the colorimeter 131 held by the user is unstable, there is a concern that the colorimetric value cannot be accurately measured. Therefore, as shown in FIG. 24, an image of the guide line 92 including, for example, a cross line that guides the colorimetry position is projected on the projection range 11a together with the image of the test pattern. As a result, the user can perform the colorimetry by, for example, aligning the colorimeter 131 with the guide line 92.

However, in a case where the colorimetry is performed in a state in which the guide line 92 is displayed, the color component of the guide line 92 is included in the colorimetric value. Therefore, as shown in FIG. 25, an image in which only the test pattern is displayed and the guide line 92 is not displayed is projected, and the image and an image (image of FIG. 24) in which the guide line 92 is displayed are displayed by being switched at a predetermined interval.

As a result, the user can obtain the accurate colorimetric value by performing the colorimetry in a case where the guide line 92 is not displayed. In the present example, the case of the first projection device 10a has been described, but the same applies to the second projection device 10b.

### <Modification Example of Guide Line>

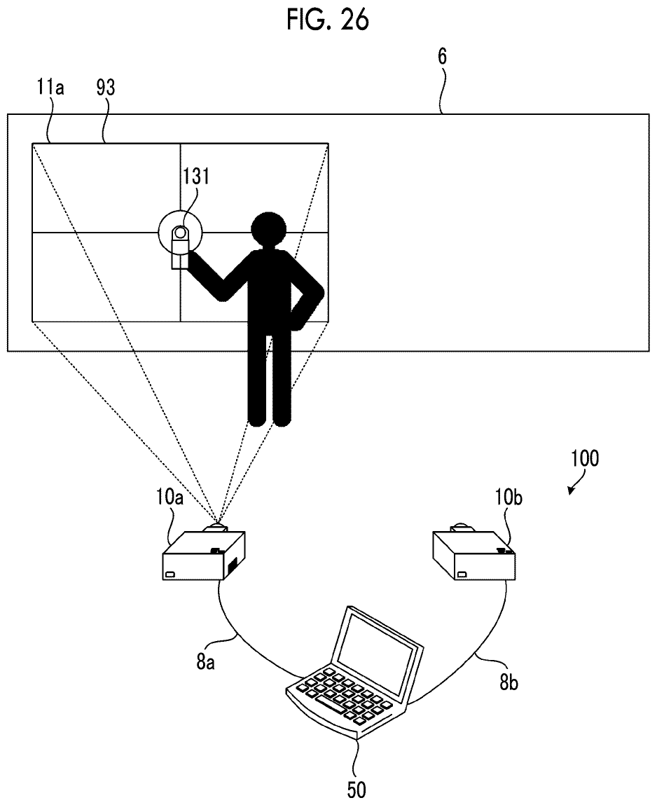

FIG. 26 is a diagram showing a modification example of the guide line that guides the colorimetry position. As shown in FIG. 26, in the guide line 93 of the modification example, a position at which the sensor of the colorimeter 131 is to be aligned in the cross-shaped guide line is, for example, a white circle.

The guide line 92 shown in FIG. 24 displays a cross line intersection portion at the position at which the sensor of the colorimeter 131 is to be aligned, whereas the guide line 93 of the modification example is a white circle in which nothing is displayed at the position at which the sensor of the colorimeter 131 is to be aligned. According to the guide line 93 of the modification example, the accurate colorimetric value can be obtained without switching the display and non-display of the guide line 93 during the colorimetry of the adjustment color.

The form of the guide line is not limited to the guide line 93 in which the position at which the sensor of the colorimeter 131 is to be aligned is a white circle, and the position at which the sensor of the colorimeter 131 is to be aligned may be recognizable to the user and may be a white image.

### <Projection Range of Image During Colorimetry>

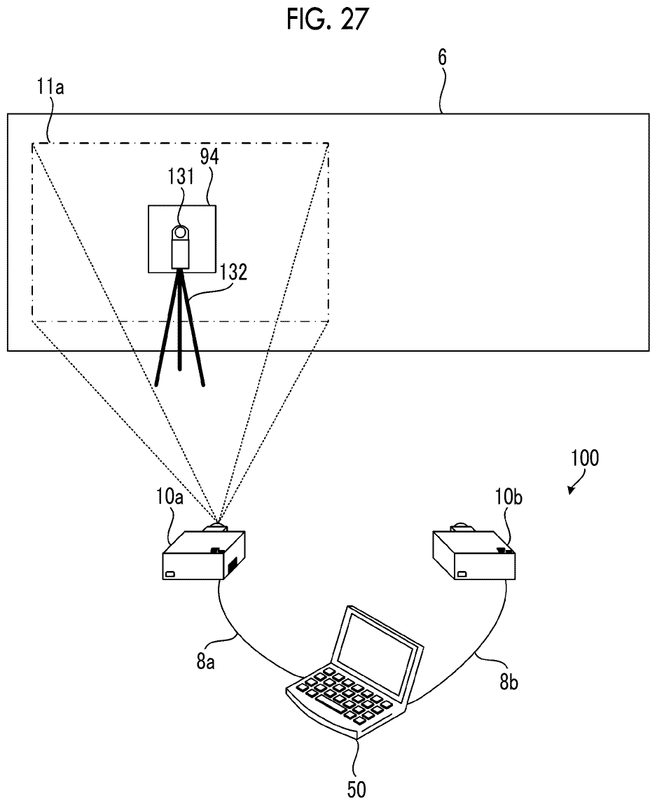

The projection range of the colorimetry image in a case of performing the color adjustment of the projection device 10 will be described with reference to FIG. 27. FIG. 27 is a diagram showing an example of the projection range of the image during the colorimetry.

In the color adjustment of the first projection device 10a and the second projection device 10b described above, for example, as shown in FIG. 1, the test pattern (colorimetry image) is projected to the entire projection ranges 11a, 11b from the first projection device 10a and the second projection device 10b toward the projection object 6, and the colorimetric value thereof is measured.

However, in a case where the place where the work is performed is, for example, a narrow closed space, the light from the first projection device 10a and the second projection device 10b may be reflected by a wall, a floor, a ceiling, or the like, and the reflected light may be incident on the colorimeter 131, which may result in an inaccurate measurement of the colorimetric value. In addition, in a case where the operator approaches the projection surface (screen) of the projection object 6 with the colorimeter 131 to perform the colorimetry, the influence of the reflection of the light due to the clothes worn by the user may also occur.

In this case, in a case of instructing the first projection device 10a to project the white test pattern, for example, the processor 51 causes the first projection device 10a to project the white test pattern to a part of the projection range 11a. In addition, in a case of instructing the second projection device 10b to project the white test pattern, for example, the processor 51 causes the second projection device 10b to project the white test pattern to a part of the projection range 11b.

Specifically, as shown in FIG. 27, in a case of measuring the colorimetric value with the first projection device 10a, the white test pattern is projected to a partial range 94 of the projection range 11a, and the colorimetry is performed by aligning the sensor of the colorimeter 131 in the range. As a result, the influence of the reflection of the light on the wall, the floor, the ceiling, or the like can be suppressed, and the colorimetric value can be accurately measured.

In the present example, the color adjustment of the first projection device 10a and the second projection device 10b has been described, but the present invention is not limited to this. For example, the same applies to the colorimetry in a case of generating the look-up table for color adjustment.

<Re-Coloring after Color Adjustment>

The processor 51 instructs the first projection device 10a to project, for example, in white in a state in which the determined previous color adjustment parameter P_{pred1} is applied to the projection performed by the first projection device 10a, and acquires an applied colorimetric value (XYZ^{white}_{PJ1}) of the light projected from the first projection device 10a.

The processor 51 determines a re-color adjustment parameter P_{pred2} to be applied to the projection performed by the first projection device 10a based on a difference between a position of an L*a*b*^{white}_{Adj2} value of the applied colorimetric value (XYZ^{white}_{PJ1}) in the Lab color space and a position of an LUT^{white}(P_{pred1}) value in the Lab color space based on the white adjustment look-up table and the previous color adjustment parameter P_{pred1}.

The applied colorimetric value (XYZ^{white}_{PJ1}) of the first projection device 10a is an example of a “fifth colorimetric value” of the present invention. L*a*b*white Adj2 is an example of a “position of fifth colorimetric value in specific color space” of the present invention. LUT^{white}(P_{pred1}) is an example of a “position in specific color space based on adjustment data for first color and first color adjustment parameter” of the present invention. The difference is a prediction error in the previous color adjustment, and includes a direction and a distance in the color space. The color adjustment parameter P_{pred1} is a color adjustment parameter determined in the previous color adjustment. The re-color adjustment parameter P_{pred2} is a color adjustment parameter determined in the re-color adjustment by the re-coloring.

Specifically, the processor 51 performs the re-coloring of the projection of the adjustment projection device (Adj) after the adjustment, and obtains a prediction error of L*a*b*^{white}_{Adj2} and LUT^{white}(P_{pred1}) calculated based on the reference white before the adjustment. In the calculation of the re-color adjustment parameter P_{pred2}, the processor 51 adds the prediction error to, for example, “LUT^{white}(p1, p2, p3)” in the expression (1) in step S33 of FIG. 13. For example, in a case where the prediction error is PredErr1^{white}, P_{pred2} is obtained by the following expression (4).

PredErr1^{white}=L*a*b*^{white}_{Adj2}−LUT^{white}(P_{pred1})

P_{pred2}=argmin(p1,p2,p3)(∥L*a*b*^{white}_{Ref}−LUT^{white}(p1,p2,p3)+PredErr1^{white}∥) (4)

After setting the previous predicted color adjustment parameter P_{pred1} in the adjustment projection device, the projection after the adjustment is re-colored based on the deviation of the prediction value, and the re-adjustment is performed, so that the accuracy of the color adjustment can be improved.

### Modification Example 1

While the configuration in which the optical axis K is not bent has been described as the configuration of the projection device 10 in FIGS. 4 and 5, a configuration in which the optical axis K is bent once or more by providing a reflective member in the optical unit 106 may be adopted.

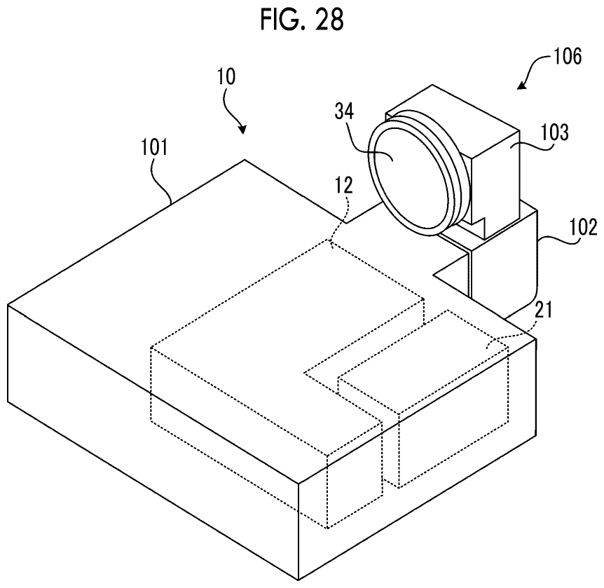

FIG. 28 is a schematic diagram showing another exterior configuration of the projection device 10. FIG. 29 is a schematic cross-sectional view of the optical unit 106 of the projection device 10 shown in FIG. 28. In FIGS. 28 and 29, the same parts as the parts shown in FIGS. 4 and 5 will be designated by the same reference numerals and will not be described.

As shown in FIG. 28, the optical unit 106 comprises a second member 103 supported by the first member 102 in addition to the first member 102 supported by the body part 101. The first member 102 and the second member 103 may be an integrated member.

As shown in FIG. 29, the optical unit 106 comprises, in addition to the first member 102, the second member 103 including a hollow portion 3A connected to the hollow portion 2A of the first member 102; the first optical system 121 and a reflective member 122 disposed in the hollow portion 2A; a second optical system 31, a reflective member 32, a third optical system 33, and the lens 34 disposed in the hollow portion 3A; the first shift mechanism 105; and a projection direction changing mechanism 104.

In the examples in FIGS. 28 and 29, the opening 2a and the opening 2b of the first member 102 are formed in surfaces perpendicular to each other. In addition, the optical projection system 23 shown in FIGS. 28 and 29 is composed of the reflective member 122, the second optical system 31, the reflective member 32, and the third optical system 33 in addition to the first optical system 121 and the lens 34 shown in FIGS. 4 and 5. With such an optical projection system 23, as shown in FIG. 29, the optical axis K is bent twice to be folded. The first optical system 121, the reflective member 122, the second optical system 31, the reflective member 32, the third optical system 33, and the lens 34 are disposed in this order from an optical modulation section 22 side along the optical axis K.

The first optical system 121 guides the light that is incident on the first member 102 from the body part 101 and that travels in the direction X1 to the reflective member 122. The reflective member 122 reflects the light incident from the first optical system 121 in the direction Y1. The reflective member 122 is composed of, for example, a mirror. In the first member 102, the opening 2b is formed on an optical path of the light reflected by the reflective member 122, and the reflected light travels to the hollow portion 3A of the second member 103 by passing through the opening 2b.

The second member 103 is a member having an approximately L-shaped cross-sectional exterior, in which an opening 3a is formed at a position facing the opening 2b of the first member 102. The light from the body part 101 that has passed through the opening 2b of the first member 102 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32. The reflective member 32 guides the light incident from the second optical system 31 to the third optical system 33 by reflecting the light in the direction X2. The reflective member 32 is composed of, for example, a mirror. The third optical system 33 includes at least one lens and guides the light reflected by the reflective member 32 to the lens 34.

The lens 34 closes an opening 3c formed in an end part of the second member 103 on a direction X2 side and is disposed in the end part. The lens 34 projects the light incident from the third optical system 33 to the projection object 6.

FIG. 29 shows the state where the first member 102 is moved as far as possible to the direction Y1 side by the first shift mechanism 105. By moving the first member 102 in the direction Y2 via the first shift mechanism 105 from the state shown in FIG. 29, the relative position between a center of the image formed by the optical modulation section 22 and the optical axis K changes, and the image G1 projected to the projection object 6 can be shifted in the direction Y1.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to a disposition position shown in FIG. 29 as long as the projection direction changing mechanism 104 can rotate the optical system. In addition, the number of rotation mechanisms is not limited to one, and a plurality of rotation mechanisms may be provided.

### <Control Program>

The control method described in the above embodiment can be realized by executing a control program prepared in advance by a computer. The present control program is executed by being recorded in a computer-readable storage medium and being read out from the storage medium. In addition, the present control program may be provided in a form of being stored in a non-transitory storage medium, such as a flash memory, or may be provided via a network, such as the Internet. The computer that executes the present control program may be included in the control device, may be included in an electronic apparatus such as a smartphone, a tablet terminal, or a personal computer that can communicate with the control device, or may be included in a server device that can communicate with the control device and the electronic apparatus.

At least the following matters are described in the present specification.

(1)

A control device comprising a processor,
in which the processor is configured to:
acquire a first colorimetric value of light of a first color that is an adjustment color and is projected from a first projection device;
acquire a second colorimetric value of light of the first color that is projected from a second projection device; and
determine a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.
   (2)

The control device according to (1),
in which the processor is configured to perform control of applying the first color adjustment parameter to the projection performed by the first projection device.
   (3)

The control device according to (1) or (2),
in which the color adjustment parameter includes a plurality of gain values corresponding to a plurality of color components.
   (4)

The control device according to any one of (1) to (3),
in which the color adjustment parameter includes a plurality of offset values corresponding to a plurality of color components.
   (5)

The control device according to any one of (1) to (4),
in which brightness based on the first colorimetric value is brighter than brightness based on the second colorimetric value.
   (6)

The control device according to any one of (1) to (5),
in which the processor is configured to determine the first color adjustment parameter based on a first color difference that is a difference between the position of the first colorimetric value in the specific color space, which is obtained in a case of being applied to the projection of the first color performed by the first projection device, and the position of the second colorimetric value in the specific color space.
   (7)

The control device according to (6),
in which the processor is configured to determine the color adjustment parameter, among the color adjustment parameters of the adjustment data, at which the first color difference is minimized as the first color adjustment parameter.
   (8)

The control device according to any one of (1) to (7),
in which the processor is configured to:
   acquire a third colorimetric value of light of a second color that is different from the first color and is projected from the first projection device;
   acquire a fourth colorimetric value of light of the second color that is projected from the second projection device; and
   determine the first color adjustment parameter based on the adjustment data for the first color, adjustment data for the second color, which indicates a relationship between the color adjustment parameter and the position in the specific color space, the first colorimetric value, the second colorimetric value, the third colorimetric value, and the fourth colorimetric value.
      (9)

The control device according to (8),
in which the processor is configured to determine the first color adjustment parameter based on an addition result of a first color difference that is a difference between the position of the first colorimetric value in the specific color space, which is obtained in a case of being applied to the projection of the first color performed by the first projection device and the position of the second colorimetric value in the specific color space, and a second color difference that is a difference between a position of the third colorimetric value in the specific color space, which is obtained in a case of being applied to the projection of the second color performed by the first projection device and a position of the fourth colorimetric value in the specific color space.
   (10)

The control device according to (9),
in which the processor is configured to determine the color adjustment parameter, among the color adjustment parameters of the adjustment data, at which the addition result is minimized as the first color adjustment parameter.
   (11)

The control device according to (9) or (10),
in which the addition result is a result of weighted addition of the first color difference and the second color difference.
   (12)

The control device according to any one of (1) to (11),
in which the first colorimetric value is a value obtained by subtracting a colorimetric value of the first projection device in a non-projection state from a colorimetric value of light projected from the first projection device in the first color, and
the second colorimetric value is a value obtained by subtracting a colorimetric value of the second projection device in a non-projection state from a colorimetric value of light projected from the second projection device in the first color.
   (13)

The control device according to any one of (1) to (12),
in which the processor is configured to:
   cause the first projection device to project an image that guides a position of a measuring device that measures a color of the light projected from the first projection device, in the acquisition of the first colorimetric value; and
   cause the second projection device to project an image that guides a position of a measuring device that measures a color of light projected from the second projection device, in the acquisition of the second colorimetric value.
      (14)

The control device according to any one of (1) to (13),
in which the processor is configured to:
   instruct the first projection device to project in the first color in a state in which the first color adjustment parameter is applied to the projection performed by the first projection device and acquire a fifth colorimetric value of the light projected from the first projection device; and
   determine a second color adjustment parameter to be applied to the projection performed by the first projection device based on a difference between a position of the fifth colorimetric value in the specific color space and a position in the specific color space based on the adjustment data for the first color and the first color adjustment parameter.
      (15)

The control device according to any one of (1) to (14),
in which the processor is configured to:
   cause the first projection device to project to a part of a projection range of the first projection device in a case of instructing the first projection device to project in the first color; and
   cause the second projection device to project to a part of a projection range of the second projection device in a case of instructing the second projection device to project in the first color.
      (16)

The control device according to any one of (1) to (15),
in which the first projection device and the second projection device have the same or similar projection characteristics.
   (17)

The control device according to (16),
in which the adjustment data for the first color is created for a plurality of color adjustment parameters for the first projection device, the second projection device, or a projection device having the same or similar projection characteristics as the first projection device and the second projection device, based on a colorimetric value of light projected by being instructed to be projected in the first color.
   (18)

A control method of a control device including a processor, the processor being configured to:
acquire a first colorimetric value of light of a first color that is an adjustment color and is projected from a first projection device;
acquire a second colorimetric value of light of the first color that is projected from a second projection device; and
determine a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.
   (19)

A control program for causing a processor included in a control device to execute a process of:
acquiring a first colorimetric value of light of a first color that is an adjustment color and is projected from a first projection device;
acquiring a second colorimetric value of light of the first color that is projected from a second projection device; and
determining a first color adjustment parameter for bringing a position of the first colorimetric value in a specific color space closer to a position of the second colorimetric value in the specific color space based on adjustment data for the first color, which indicates a relationship between a color adjustment parameter and the position in the specific color space, the first colorimetric value, and the second colorimetric value.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2023-138035) filed on Aug. 28, 2023, the content of which is incorporated in the present application by reference.

### EXPLANATION OF REFERENCES

1: projection section
2: operation reception section
2A, 3A: hollow portion
2a, 2b, 3a, 3c, 15a: opening
4: control section
4a: storage medium
5: communication section
6: projection object
8a, 8b: communication cable
10: projection device
10a: first projection device
10b: second projection device
11a, 11b: projection range
12: optical modulation unit
15: housing
21: light source
22: optical modulation section
23: optical projection system
24: control circuit
31: second optical system
32, 122: reflective member
33: third optical system
34: lens
50: computer
51: processor
52: memory
53: communication interface
54: user interface
59: bus
61: Lab color space
62, 81: look-up table
64: search path
63, 66, 71, 72: spatial position
82 to 84: color adjustment parameter
91: work light
92, 93: guide line
94: partial range
100: projection system
101: body part
102: first member
103: second member
104: projection direction changing mechanism
105: first shift mechanism
106: optical unit
121: first optical system
131: colorimeter
132: tripod
G1: image

What is claimed is:

1. A control device comprising:
a processor,
wherein the processor is configured to:
acquire a first colorimetric value of light of a first color that is an adjustment color and is projected from a first projection device;
acquire a second colorimetric value of light of the first color that is projected from a second projection device; and
determine a first color adjustment parameter for bringing a position of the first colorimetric value in a specific color space closer to a position of the second colorimetric value in the specific color space based on adjustment data for the first color, the first colorimetric value, and the second colorimetric value, the adjustment data indicating a relationship between a color adjustment parameter and the position in the specific color space.

2. The control device according to claim 1,
wherein the processor is configured to perform control of applying the first color adjustment parameter to the projection performed by the first projection device.

3. The control device according to claim 1,
wherein the color adjustment parameter includes a plurality of gain values corresponding to a plurality of color components.

4. The control device according to claim 1,
wherein the color adjustment parameter includes a plurality of offset values corresponding to a plurality of color components.

5. The control device according to claim 1,
wherein brightness based on the first colorimetric value is brighter than brightness based on the second colorimetric value.

6. The control device according to claim 1,
wherein the processor is configured to determine the first color adjustment parameter based on a first color difference that is a difference between the position of the first colorimetric value in the specific color space, which is obtained in a case of being applied to the projection of the first color performed by the first projection device, and the position of the second colorimetric value in the specific color space.

7. The control device according to claim 6,
wherein the processor is configured to determine the color adjustment parameter, among the color adjustment parameters of the adjustment data, at which the first color difference is minimized as the first color adjustment parameter.

8. The control device according to claim 1,
wherein the processor is configured to:
acquire a third colorimetric value of light of a second color that is different from the first color and is projected from the first projection device;
acquire a fourth colorimetric value of light of the second color that is projected from the second projection device; and
determine the first color adjustment parameter based on the adjustment data for the first color, adjustment data for the second color, which indicates a relationship between the color adjustment parameter and the position in the specific color space, the first colorimetric value, the second colorimetric value, the third colorimetric value, and the fourth colorimetric value.

9. The control device according to claim 8,
wherein the processor is configured to determine the first color adjustment parameter based on an addition result of a first color difference that is a difference between the position of the first colorimetric value in the specific color space, which is obtained in a case of being applied to the projection of the first color performed by the first projection device and the position of the second colorimetric value in the specific color space, and a second color difference that is a difference between a position of the third colorimetric value in the specific color space, which is obtained in a case of being applied to the projection of the second color performed by the first projection device and a position of the fourth colorimetric value in the specific color space.

10. The control device according to claim 9,
wherein the processor is configured to determine the color adjustment parameter, among the color adjustment parameters of the adjustment data, at which the addition result is minimized as the first color adjustment parameter.

11. The control device according to claim 9,
wherein the addition result is a result of weighted addition of the first color difference and the second color difference.

12. The control device according to claim 1,
wherein the first colorimetric value is a value obtained by subtracting a colorimetric value of the first projection device in a non-projection state from a colorimetric value of light projected from the first projection device in the first color, and
the second colorimetric value is a value obtained by subtracting a colorimetric value of the second projection device in a non-projection state from a colorimetric value of light projected from the second projection device in the first color.

13. The control device according to claim 1,
wherein the processor is configured to:
cause the first projection device to project an image that guides a position of a measuring device that measures a color of the light projected from the first projection device, in the acquisition of the first colorimetric value; and
cause the second projection device to project an image that guides a position of a measuring device that measures a color of light projected from the second projection device, in the acquisition of the second colorimetric value.

14. The control device according to claim 1,
wherein the processor is configured to:
instruct the first projection device to project in the first color in a state in which the first color adjustment parameter is applied to the projection performed by the first projection device and acquire a fifth colorimetric value of the light projected from the first projection device; and
determine a second color adjustment parameter to be applied to the projection performed by the first projection device based on a difference between a position of the fifth colorimetric value in the specific color space and a position in the specific color space based on the adjustment data for the first color and the first color adjustment parameter.

15. The control device according to claim 1,
wherein the processor is configured to:
cause the first projection device to project to a part of a projection range of the first projection device in a case of instructing the first projection device to project in the first color; and
cause the second projection device to project to a part of a projection range of the second projection device in a case of instructing the second projection device to project in the first color.

16. The control device according to claim 1,
wherein the first projection device and the second projection device have the same or similar projection characteristics.

17. The control device according to claim 16,
wherein the adjustment data for the first color is created for a plurality of color adjustment parameters for the first projection device, the second projection device, or a projection device having the same or similar projection characteristics as the first projection device and the second projection device, based on a colorimetric value of light projected by being instructed to be projected in the first color.

18. A control method of a control device including a processor, the processor being configured to:
acquire a first colorimetric value of light of a first color that is an adjustment color and is projected from a first projection device;
acquire a second colorimetric value of light of the first color that is projected from a second projection device; and
determine a first color adjustment parameter for bringing a position of the first colorimetric value in a specific color space closer to a position of the second colorimetric value in the specific color space based on adjustment data for the first color, the first colorimetric value, and the second colorimetric value, the adjustment data indicating a relationship between a color adjustment parameter and the position in the specific color space.

19. A non-transitory computer-readable storage medium storing a control program for causing a processor included in a control device to execute a process, the process comprising:
acquiring a first colorimetric value of light of a first color that is an adjustment color and is projected from a first projection device;
acquiring a second colorimetric value of light of the first color that is projected from a second projection device; and
determining a first color adjustment parameter for bringing a position of the first colorimetric value in a specific color space closer to a position of the second colorimetric value in the specific color space based on adjustment data for the first color, the first colorimetric value, and the second colorimetric value, the adjustment data indicating a relationship between a color adjustment parameter and the position in the specific color space.
